(19) United States
(12) Patent Application Publication
(10) Pub. No.: US 2019/0266304 A1
(43) Pub. Date: Aug. 29, 2019

(54) VERIFICATION APPARATUS AND VERIFICATION METHOD

(71) Applicant: FUJITSU LIMITED, Kawasaki-shi (JP)

(72) Inventors: Yoshiaki Hiratsuka, Ota (JP); Koji DEMIZU, Atsugi (JP)

(73) Assignee: FUJITSU LIMITED, Kawasaki-shi (JP)

(21) Appl. No.: 16/267,567

(22) Filed: Feb. 5, 2019

(30) Foreign Application Priority Data
Feb. 28, 2018 (JP) 2018-035550

(51) Int. Cl. G06F 17/50; H01B 7/00

(52) U.S. Cl. CPC G06F 17/5036; H01B 7/0045; G06F 17/5086; G06F 17/5077

(57) ABSTRACT

A non-transitory computer-readable recording medium storing a program that causes a computer to execute a procedure, the procedure includes generating a search range configured to include a constituent point for constituting a line which approximates a center route of a string-like component or a band-like component disposed in a device at which an influence of electromagnetic noise is verified, checking whether there is an interference between the search range and a range around a component mounted on the device, and visualizing a result of the checking.

### CROSS-REFERENCE TO RELATED APPLICATION

This application is based upon and claims the benefit of priority of the prior Japanese Patent Application No. 2018-035550, filed on Feb. 28, 2018, the entire contents of which are incorporated herein by reference.

### FIELD

The embodiments discussed herein are related to a verification program apparatus, and a verification method.

### BACKGROUND

In designing a wire harness, in order to minimize the influence of electromagnetic noise radiated from an electronic apparatus, the wire harness may be disposed away from a noise generating source such as a printed circuit board, or disposed along a conductive case surface. Thus, for example, a device has been known for accurately modeling string-like or band-like components at a design stage of the string-like or band-like components such as the wire harness. The device accepts an input of numerical values for modeling an electric wire constituting the wire harness and a fixing tool disposed on a jig plate and capable of routing the wire harness on the jig plate. The device displays the electric wire routed in the fixing tool based on information on the electric wire, which is obtained from a result of an operation based on an algorithm that avoids positioning the electric wire as if the electric wire is buried in other objects including another electric wire with a numerical value including an input numerical value as an initial value.

A cable wiring route design supporting device that facilitates three-dimensional wiring of cables is also known. The device obtains a plurality of control points indicating a point through which the cable needs to be passed and calculates a first route of the cable in consideration of bending of the cable caused by a weight of the cable itself so that the cable passes through the plurality of control points. The device determines whether a condition that the wiring route needs to be satisfied, which is stored in a storage, is satisfied, and when it is determined that a first route does not satisfy the condition, the device calculates a second route different from the first route. Further, there is also known a technique of specifying a point where it is desirable to twist two wires, in order to suppress the influence of electronic noise to be minimized. The device determines whether the two wires satisfy the condition, and when it is determined that the condition is not satisfied, the device adjusts the route of each wire so as to twist the two wires.

Related techniques are disclosed in, for example, Japanese Laid-open Patent Publication Nos. 2013-149099, 2009-193156, and 2009-199386.

### SUMMARY

According to an aspect of the embodiments, a non-transitory computer-readable recording medium storing a program that causes a computer to execute a procedure, the procedure includes generating a search range configured to include a constituent point for constituting a line which approximates a center route of a string-like component or a band-like component disposed in a device at which an influence of electromagnetic noise is verified, checking whether there is an interference between the search range and a range around a component mounted on the device, and visualizing a result of the checking.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an interference state between a harness and a forbidden range according to a first embodiment;

FIGS. 2A and 2B are diagrams illustrating an example of a relationship between the harness and a recommended range according to the first embodiment;

FIG. 3 is a diagram illustrating an example of a verification process;

FIG. 4 is a diagram illustrating another example of the verification process;

FIG. 5 is a block diagram illustrating an example of a configuration of a verification apparatus according to the first embodiment;

FIG. 6 is a diagram illustrating an example of a range DB according to the first embodiment;

FIG. 7 is a diagram illustrating an example of a search sphere DB according to the first embodiment;

FIG. 8 is a diagram illustrating an example of a nonconformance DB according to the first embodiment;

FIG. 9 is a diagram illustrating an example of a center route and an approximate straight line according to the first embodiment;

FIGS. 10A and 10B are diagrams illustrating an example of a search range generating process according to the first embodiment;

FIG. 11 is a diagram illustrating an example of a nonconformance result display according to the first embodiment;

FIG. 12 is a diagram illustrating another example of the nonconformance result display according to the first embodiment;

FIG. 13 is a diagram illustrating another example of the nonconformance result display according to the first embodiment;

FIG. 14 is a flowchart illustrating an example of a verification process according to the first embodiment;

FIG. 15 is a flowchart illustrating an example of an interference check process according to the first embodiment;

FIG. 16 is a flowchart illustrating an example of a determination process according to the first embodiment;

FIG. 17 is a flowchart illustrating an example of a visualization process according to the first embodiment;

FIG. 18 is a diagram illustrating an example of a relationship between a harness and an opening according to a second embodiment;

FIG. 19 is a block diagram illustrating an example of a configuration of a verification apparatus according to the second embodiment;

FIG. 20 is a diagram illustrating an example of a nonconformance DB according to the second embodiment;

FIG. 21 is a diagram illustrating an example of an opening DB according to the second embodiment;

FIG. 22 is a diagram illustrating an example of an exposure portion check process according to the second embodiment;

FIG. 23 is a diagram illustrating an example of a nonconformance result display according to the second embodiment;

FIG. 24 is a flowchart illustrating an example of a verification process according to the second embodiment;

FIG. 25 is a flowchart illustrating an example of an exposure portion specifying process according to the second embodiment;

FIG. 26 is a flowchart illustrating an example of a determination process according to the second embodiment;

FIG. 27 is a block diagram illustrating an example of a configuration of a verification apparatus according to a third embodiment;

FIG. 28 is a diagram illustrating an example of a correction display according to the third embodiment;

FIG. 29 is a flowchart illustrating an example of a verification process according to the third embodiment;

FIG. 30 is a flowchart illustrating an example of a recommended route generating process according to the third embodiment;

FIG. 31 is a flowchart illustrating an example of a route adjustment process according to the third embodiment;

FIG. 32 is a diagram illustrating an example of a nonconformance result display according to a fourth embodiment;

FIGS. 33A and 33B are diagrams illustrating another example of the nonconformance result display according to the fourth embodiment; and

FIG. 34 is a diagram illustrating an example of a hardware configuration.

### DESCRIPTION OF EMBODIMENTS

Since a string-like or band-like component such as a wire harnesses flexibly changes in shape, a movement area is large. In the above technique, the calculation amount becomes large when it is verified whether, for example, the wire harness interferes in the component of an apparatus.

Hereinafter, embodiments of a technique capable of reducing the calculation amount at the time of route verification of the string-like or band-like component such as the wire harness will be described in detail with reference to the accompanying drawings. In addition, the present disclosure is not limited by the embodiments. Further, the embodiments described below may be appropriately combined with each other within a scope that does not cause a contradiction.

### First Embodiment

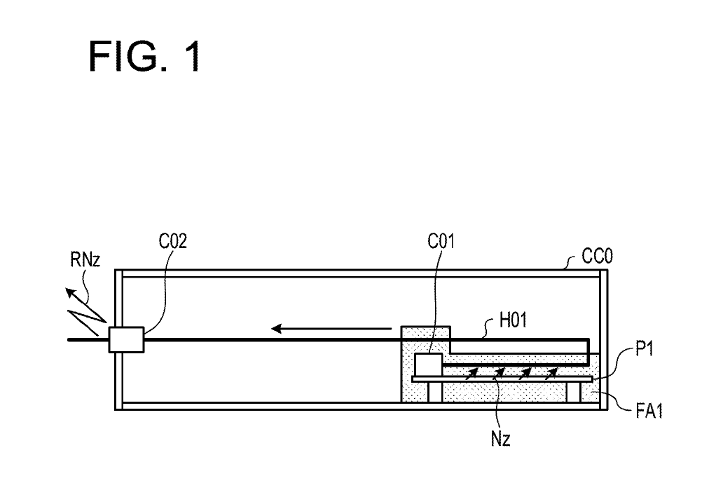

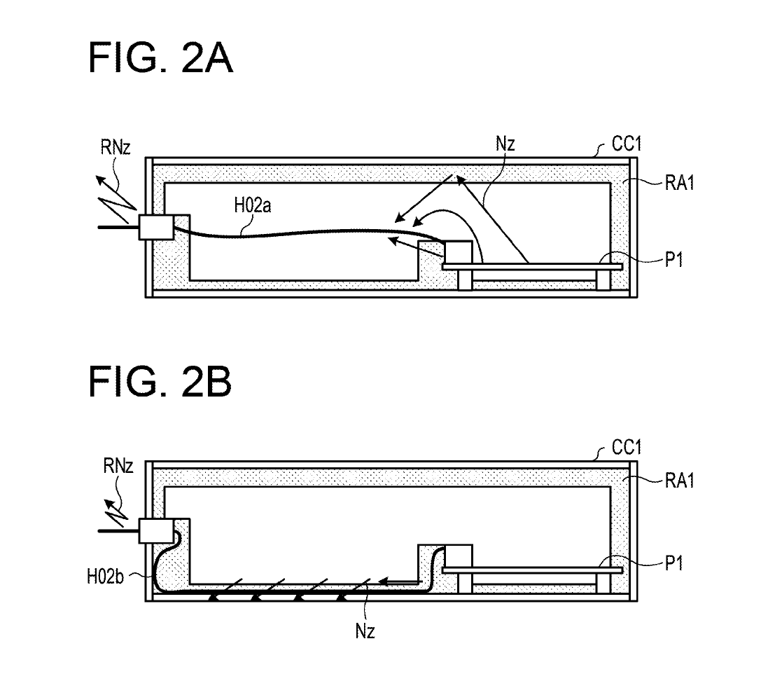

First, with reference to FIGS. 1, 2A, and 2B, a relationship between arrangement of string-like or band-like components such as the wire harness and electromagnetic noise in an electronic apparatus to be designed will be described. Further, in the following description, the electronic apparatus to be designed may be simply referred to as an “apparatus”, and the string-like or band-like component such as the wire harness may be simply referred to as “harness”.

The electromagnetic noise is generated by, for example, an operation of a high-speed signal (clock) such as a printed circuit board which is a component of the apparatus, and propagated to a harness. Therefore, when the harness is designed, it is desirable to keep the harness away from, for example, a printed circuit board that generates the electromagnetic noise. Further, in the following description, a range which needs to be avoided for the reduction of the electromagnetic noise, such as a periphery of the printed circuit board may be referred to as a “forbidden range.” In addition, in the following description, the electromagnetic noise may be simply referred to as “noise ”

FIG. 1 is a diagram illustrating an example of an interference state between a harness and a forbidden range according to a first embodiment. In FIG. 1, a harness H01 is exposed to the outside of a case CC0 through a connector C02 with a connector C01 on a printed circuit board P1 as a start point.

In FIG. 1, the printed circuit board P1 generates noise accompanied by an operation of a clock. As illustrated in FIG. 1, when the harness H01 passes through a forbidden range FA1 around the printed circuit board P1, noise Nz is propagated from the printed circuit board P1 to the harness H01. In this case, noise RNz is radiated from the harness H01 to the outside of a case at the connector C02. Therefore, it is desirable that the harness H01 avoids the forbidden range FA1.

Meanwhile, when the harness is disposed on a proximity surface of a conductive case, the noise propagated to the harness is propagated to the conductive case, so that the noise emitted from the harness to the outside of the case may be reduced. Further, in the following description, the range that needs to be passed through for the reduction of the noise, such as the proximity surface of the conductive case, may be referred to as a “recommended range.”

FIGS. 2A and 2B are diagrams illustrating an example of a relationship between the harness and a recommended range according to the first embodiment. Unlike the example illustrated in FIG. 1, in FIGS. 2A and 2B, a harness H02a does not pass over the printed circuit board P1. However, in this case as well, the noise Nz radiated from the printed circuit board P1 and reflected on a conductive case CC1 is propagated to the harness H02a as illustrated in FIG. 2A. In this case, when the harness H02a does not pass through a recommended range RA1, the noise RNz is not reduced but is radiated to the outside of the case.

Meanwhile, as illustrated in FIG. 2B, when a harness H02b passes through the recommended range RA1, the noise Nz propagated to the harness H02b is propagated to the conductive case CC1, so that the noise RNz radiated to the outside of the case from the harness H02b may be reduced.

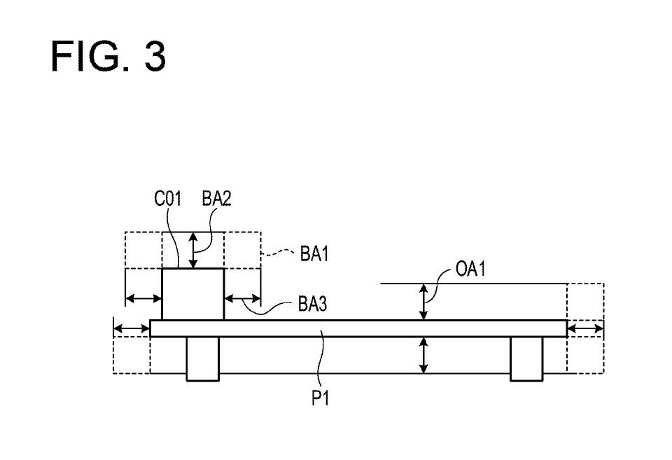

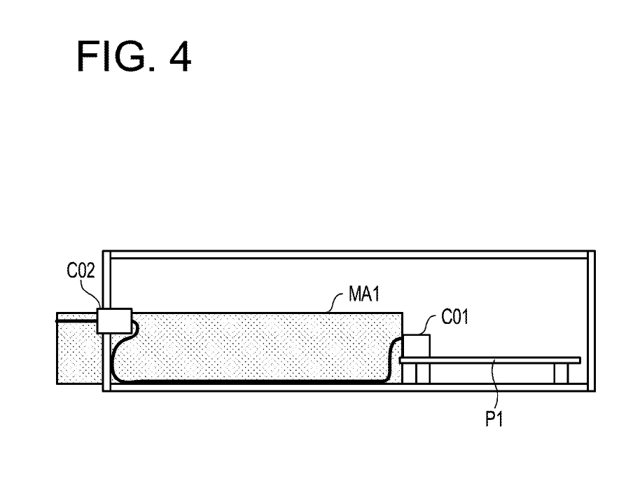

However, when the placement of string-like flexible objects such as the harnesses in the apparatus is verified, for example, all empty spaces on the route of the harness may be calculated from all designed components of the apparatus to measure, for example, a free curve pair parallelism. An example of the verification process will be described with reference to FIGS. 3 and 4.

FIG. 3 is a diagram illustrating an example of the verification process. In the verification process illustrated in FIG. 3, positions of components such as a noise generation source and the conductive case, such as the printed circuit board P1 and the connector C01, are specified. In addition, for example, a range OA1 obtained by offsetting the surface of the printed circuit board P1 by a certain distance is specified and used for checking the interference with the harness.

In this case, in a place where the surface and the surface of the component side are changed, for example, in a range BA1 on an extension line of ranges BA2 and BA3 obtained by offsetting the surface of the connector C01 by a certain distance, the harness may become a mountain fold or a valley fold. In this case, for example, in order to generate a surface at a predetermined distance, for example, a Boolean operation is performed with respect to the ranges BA2 and BA3, and as a result, the calculation amount may increase.

An interference check between the harness and the component may be performed by offsetting a cross-sectional diameter of the harness by a predetermined distance on the same route of the harness. FIG. 4 is a diagram illustrating another example of the verification process. In FIG. 4, for example, a range MA1 obtained by offsetting the cross-sectional diameter of the harness from the connector C01 to the connector C02 is specified as a maximum outer shape of the harness.

In this case, since the harness has flexibility, the maximum outer shape of the harness specified according to the cross-sectional diameter of the harness becomes large. When the maximum outer shape of the harness becomes large, the effect in reducing a calculation target using the maximum outer shape by, for example, Axis-Aligned Bounding Box (AABB) may be expected.

Therefore, in the embodiment, the verification apparatus 100, which will be described later, extracts a center route of a string with the harness as the string-like component, generates a spherical model centered on the route, and performs the interference check between the spherical model and each component. The verification apparatus 100 generates a constituent point corresponding to the route of the harness and generates a search sphere centered on the constituent point. In addition, the verification apparatus 100 verifies an interference relationship between the search sphere and each component, and visualizes a verification result. As a result, it is possible to reduce the calculation amount at the time of verifying the route.

### [Functional Block]

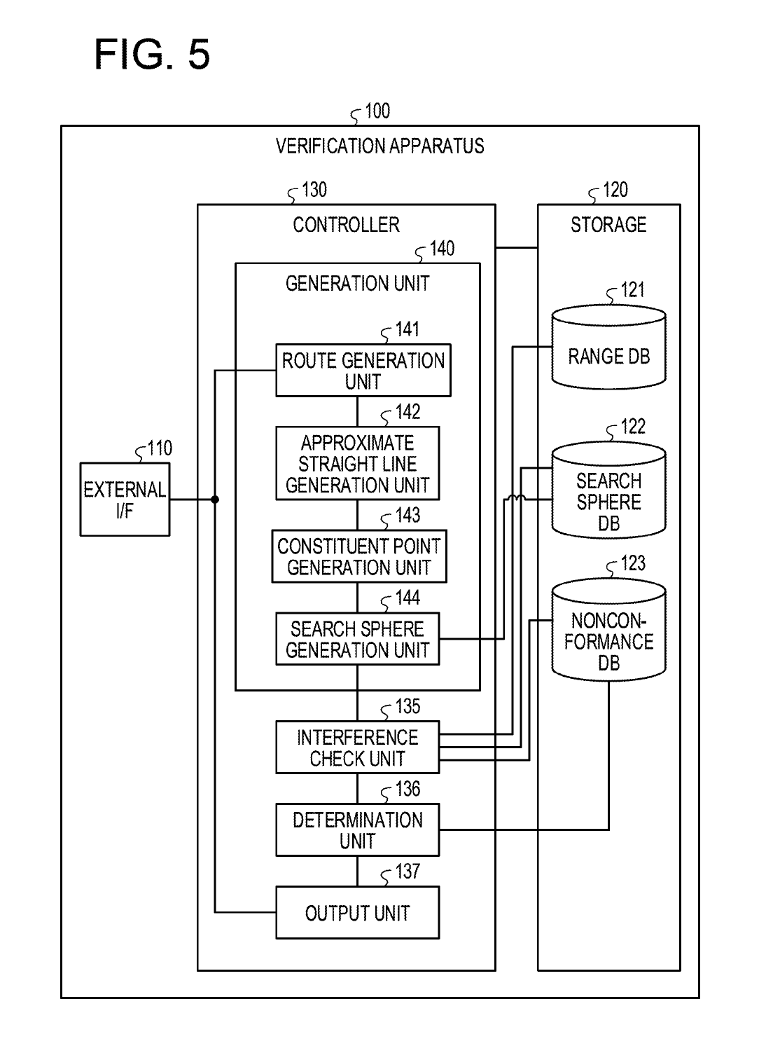

Next, an example of the verification apparatus 100 according to the embodiment will be described with reference to FIG. 5. FIG. 5 is a block diagram illustrating an example of a configuration of a verification apparatus according to the first embodiment. As illustrated in FIG. 5, the verification apparatus 100 according to the embodiment includes an external interface (I/F) 110, a storage 120, and a controller 130.

The external I/F 110 controls communication and input/output with, for example, other computers, such as a terminal (not illustrated) of a user (not illustrated) of the verification apparatus 100. Further, the external I/F 110 may be, for example, a device that controls input/output with a user such as the user of the verification apparatus 100. The external I/F 110 is, for example, a communication interface such as a network interface card (NIC), but is not limited thereto. The external I/F 110 may be constituted by an input device such as a keyboard or an output device such as a display.

The storage 120 is, for example, an example of a storage device that stores, for example, various data such as a program executed by the controller 130, and is, for example, a memory. The storage 120 includes a range database DB 121, a search sphere DB 122, and a nonconformance DB 123. Further, in the following description, a database may be referred to as “DB.”

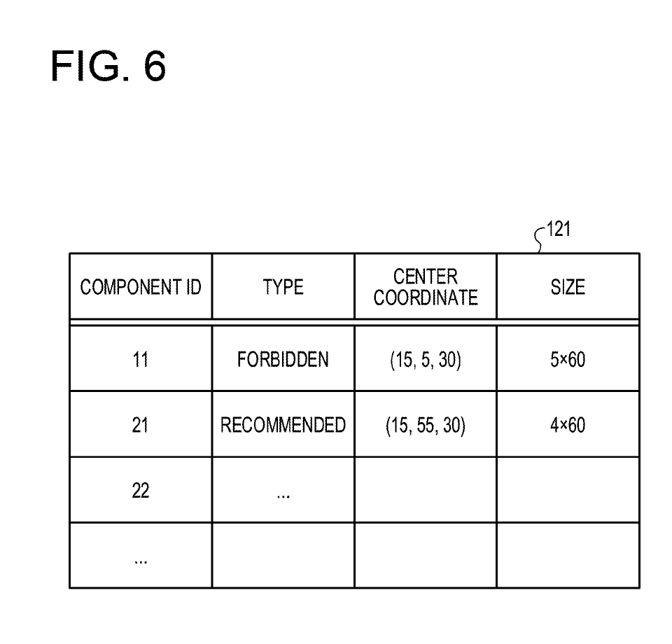

The range DB 121 stores information regarding a component constituting the apparatus. FIG. 6 is a diagram illustrating an example of a range DB according to the first embodiment. As illustrated in FIG. 6, the range DB 121 stores, for example, “type,” “center coordinate,” and “size” in association with “component ID.” Further, the information stored in the range DB 121 is input in advance by, for example, a manager (not illustrated) of the verification apparatus 100. The range DB 121 stores, for example, each component as one record.

In FIG. 6, “component identifier (ID)” is an identifier for uniquely identifying a component constituting the apparatus. The “type” is information indicating whether a component corresponding to the component ID is a component which causes the forbidden range such as the printed circuit board P1 or a component which causes the recommended range such as the conductive case CC1. The “center coordinate” and the “size” are information indicating a position of the component corresponding to the component ID in the apparatus and a size of the corresponding component.

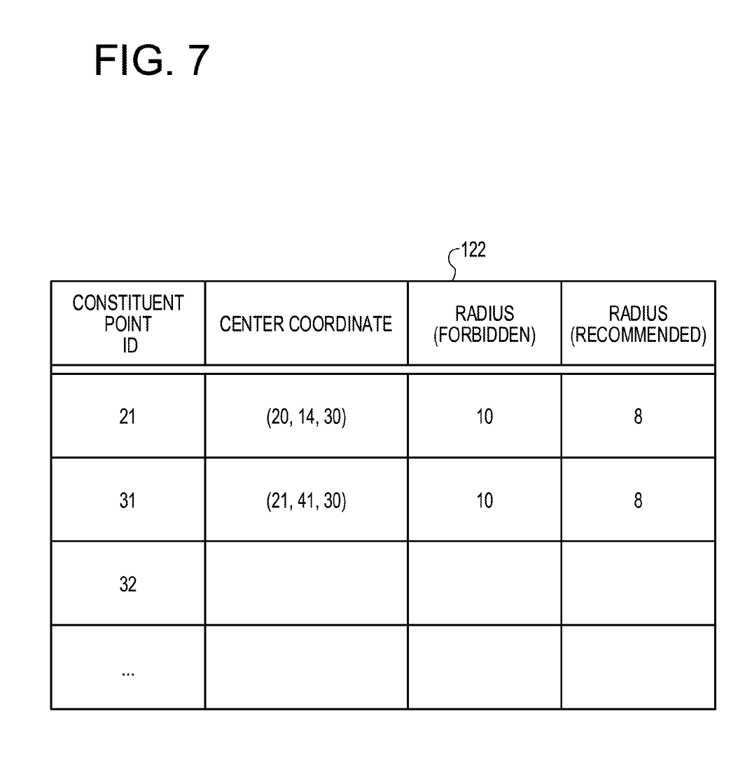

The search sphere DB 122 stores information on search spheres generated along the approximate straight line of the harness. FIG. 7 is a diagram illustrating an example of a search sphere DB according to the first embodiment. As illustrated in FIG. 7, the search sphere DB 122 stores “constituent point ID,” “center coordinate,” “radius (forbidden),” and “radius (recommended)” in association with each other. Further, the information stored in the search sphere DB 122 is input by, for example, a search sphere generation unit 144 of the verification apparatus 100 to be described later. The search sphere DB 122 stores, for example, each search sphere as one record.

In FIG. 7, the “constituent point ID” is an identifier for uniquely identifying a constituent point corresponding to the generated search range. The “center coordinate” is information indicating a position of the search range corresponding to the constituent point ID in the harness. The “radius (prohibition)” is information indicating the size of the search range used for checking interference with the forbidden range. The “radius (recommended)” is information indicating a size of the search range used for checking interference with the recommended range.

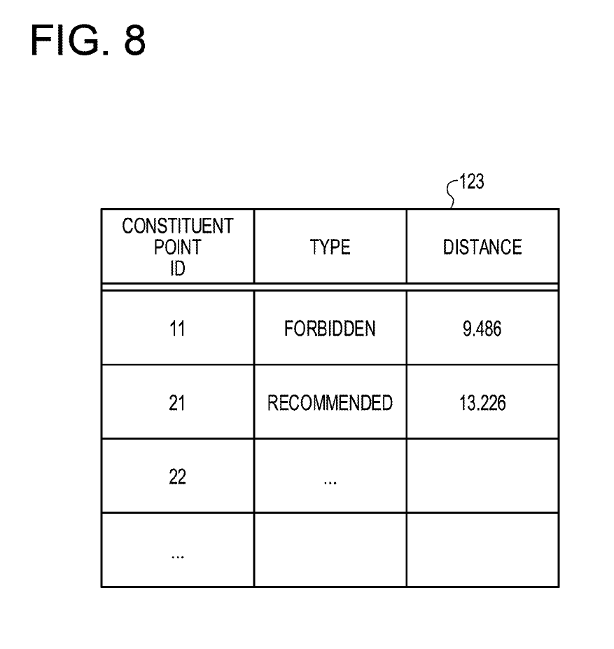

In the interference check process, the nonconformance DB 123 stores information on a search range determined to be nonconforming. FIG. 8 is a diagram illustrating an example of a nonconformance DB according to the first embodiment. As illustrated in FIG. 8, the nonconformance DB 123 stores, for example, “type” and “distance” in association with the “constituent point ID.” Further, the information stored in the nonconformance DB 123 is input by, for example, an interference check unit 135 of the verification apparatus 100 to be described later. The nonconformance DB 123 stores, for example, each search range determined to be nonconforming as one record.

In FIG. 8, the “configuration ID” is information indicating a constituent point corresponding to a search range determined to be nonconforming. The “type” is information indicating whether the type of nonconformance is interference with the forbidden range or deviation from the recommended range. The “distance” is information indicating a position of the component corresponding to the component ID in the apparatus and a size of the corresponding component.

Referring back to FIG. 5, the controller 130 is a processing unit that controls the entire verification apparatus 100, and is, for example, a processor. The controller 130 includes a generation unit 140, an interference check unit 135, a determination unit 136, and an output unit 137. Further, the generation unit 140, the interference check unit 135, the determination unit 136, and the output unit 137 are an example of an electronic circuit included in the processor and an example of a process executed by the processor.

The generation unit 140 generates the route of the harness within the apparatus and generates the search range on the periphery of the harness. The generation unit 140 includes a route generation unit 141, an approximate straight line generation unit 142, a constituent point generation unit 143, and a search sphere generation unit 144.

The route generation unit 141 generates a temporary route of the harness passing through the apparatus. The route generation unit 141 temporarily sets the route of the harness at a position that does not interfere with the components by referring to, for example, the range DB 121 illustrated in FIG. 6.

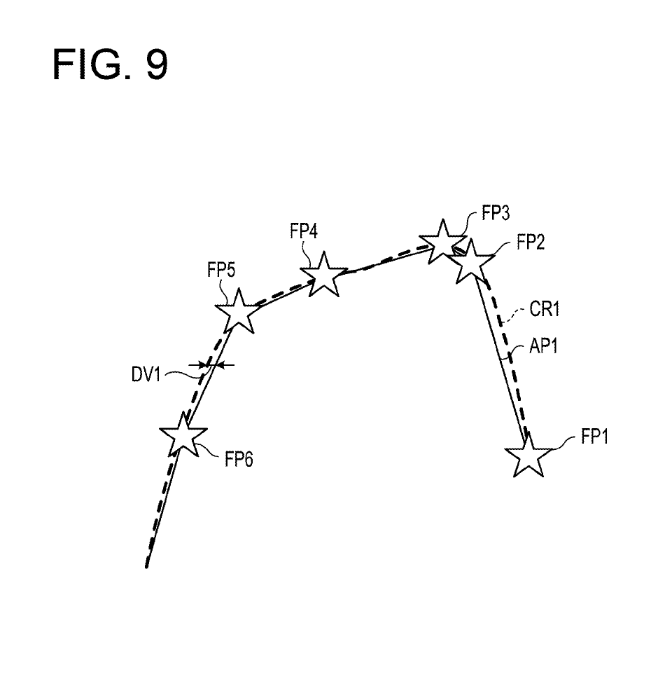

The approximate straight line generation unit 142 generates a straight line that approximates the temporary route of the generated harness. FIG. 9 is a diagram illustrating an example of a center route and an approximate straight line according to the first embodiment. As illustrated in FIG. 9, for example, the approximate straight line generation unit 142 generates an approximate straight line AP1 that minimizes a divergence DV1 with respect to a temporary route CR1 of the harness. For example, the approximate straight line AP1 generated by the approximate straight line generation unit 142 includes a plurality of straight lines connecting refraction points FP1 to FP6 of the temporary route CR1 of the harness.

The constituent point generation unit 143 generates a constituent point to be the center of the search sphere on the generated approximate straight line. For example, the constituent point generation unit 143 sets six refraction points from refraction points FP1 to FP6 on the approximate straight line AP1 illustrated in FIG. 9 as the constituent points.

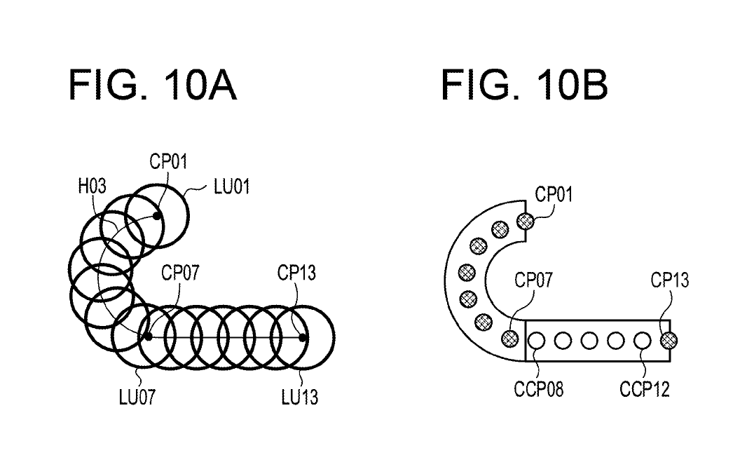

The search sphere generation unit 144 generates the search sphere centered on the generated constituent point. FIGS. 10A and 10B are diagrams illustrating an example of a search range generating process according to the first embodiment. For example, as illustrated in FIG. 10A, search spheres LU01 to LU13 are generated for the periphery from the constituent points CP01 to CP13 on the harness H03, respectively.

In order to reduce the calculation amount, the constituent point generation unit 143 may generate the constituent point only in a portion where the harness H03 is curved, and may suppress generation of the constituent point in a straight line portion. For example, as illustrated in FIG. 10B, in a case where the harness H03 between the constituent points CP07 and CP13 forms the straight line, the constituent point generation unit 143 may suppress generation of the constituent point between the constituent points CP07 and CP13.

In this case, the search sphere generation unit 144 may newly interpolate respective constituent points from CCP08 to CCP12 between the constituent points CP07 and CP13 in order to generate the search sphere even in a portion where generation of the constituent point is suppressed.

The interference check unit 135 performs the interference check process between the search sphere and the forbidden range or the recommended range. The interference check unit 135 refers to the range DB 121 and the search sphere DB 122 to determine whether the search sphere interferes with the forbidden range. Further, the interference check unit 135 is an example of a check unit.

When it is determined that the search sphere interferes with the forbidden range, the interference check unit 135 stores information on the constituent point corresponding to the search sphere and information on the portion with a shortest distance to the constituent point in the forbidden range, in the nonconformance DB 123. Further, in the following description, the portion having the shortest distance to the constituent point may be referred to as the “shortest point.”

The interference check unit 135 refers to the range DB 121 and the search sphere DB 122 to determine whether the search sphere is included in the recommended range. When it is determined that the search sphere deviates from the recommended range, the interference check unit 135 stores the information on the constituent point corresponding to the search sphere and information on the shortest point in the recommended range, in the nonconformance DB 123.

The determination unit 136 determines whether successive constituent points constitute a nonconformance range. The determination unit 136 extracts the constituent points registered in the nonconformance DB 123. In addition, when the constituent points adjacent to the extracted constituent points are registered in the nonconformance DB 123, the determination unit 136 determines that a section including a plurality of corresponding constituent points is a nonconformance section and calculates a total length of the section. Then, the determination unit 136 calculates a ratio of the section to the entire harness.

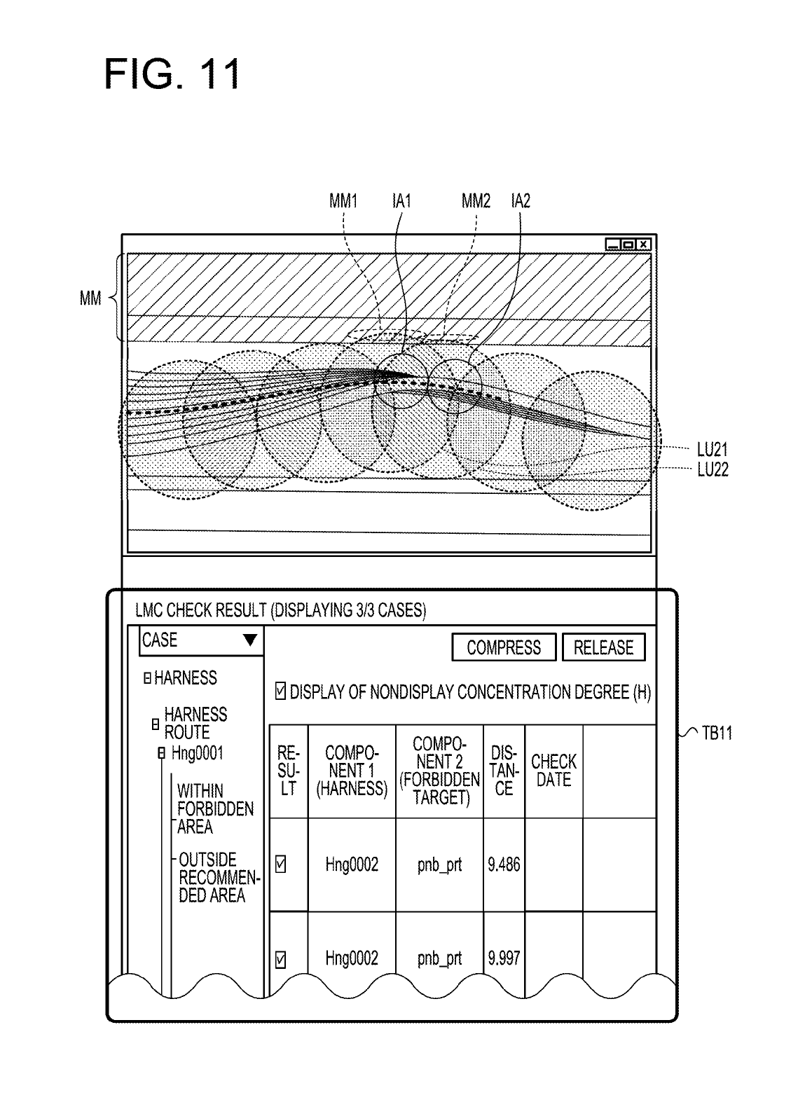

The output unit 137 outputs a result of the verification process. An example of the result of the verification process in the embodiment will be described with reference to FIGS. 11 to 13. FIG. 11 is a diagram illustrating an example of a nonconformance result display according to the first embodiment. FIG. 11 illustrates that a search sphere LU21 corresponding to a portion IA1 of the harness interferes with a nonconformance portion MM1. Further, FIG. 11 illustrates that a search sphere LU22 corresponding to a portion IA2 of the harness interferes with a nonconformance portion MM2. In addition, the nonconformance result display illustrated in FIG. 11 further includes a table TB11 representing information on the constituent points included in the nonconformance section.

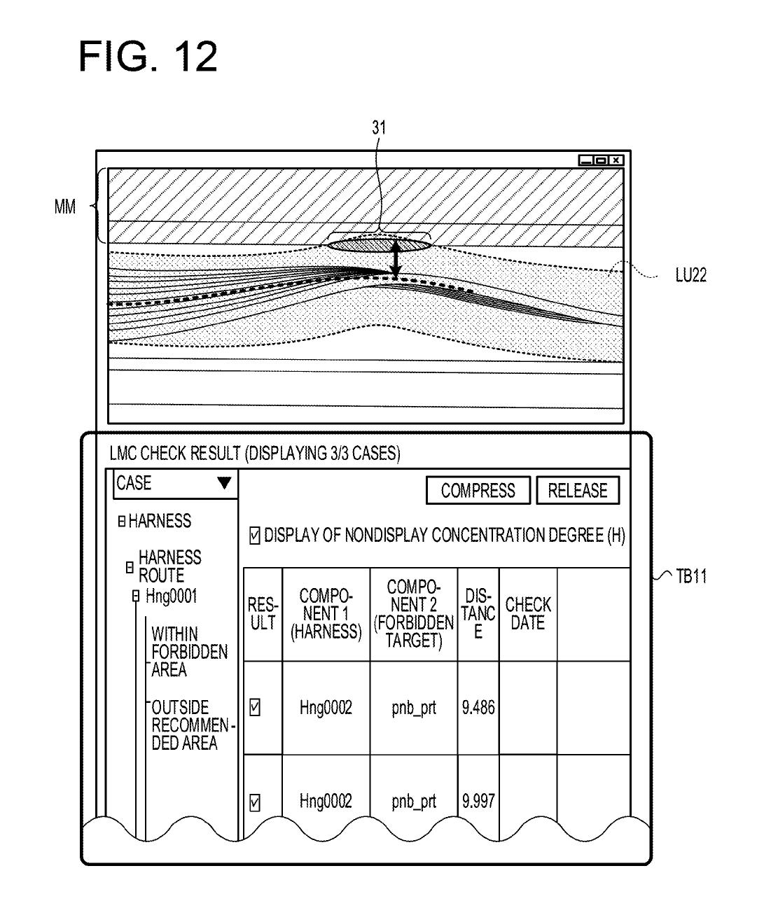

The display of the search range may be other aspects. FIG. 12 is a diagram illustrating another example of the nonconformance result display according to the first embodiment. FIG. 12 illustrates the search range LU 22 in a cylindrical shape in which a plurality of search spheres are connected. FIG. 12 further includes an emphasis display 31 of nonconformance portions MM1 and MM2.

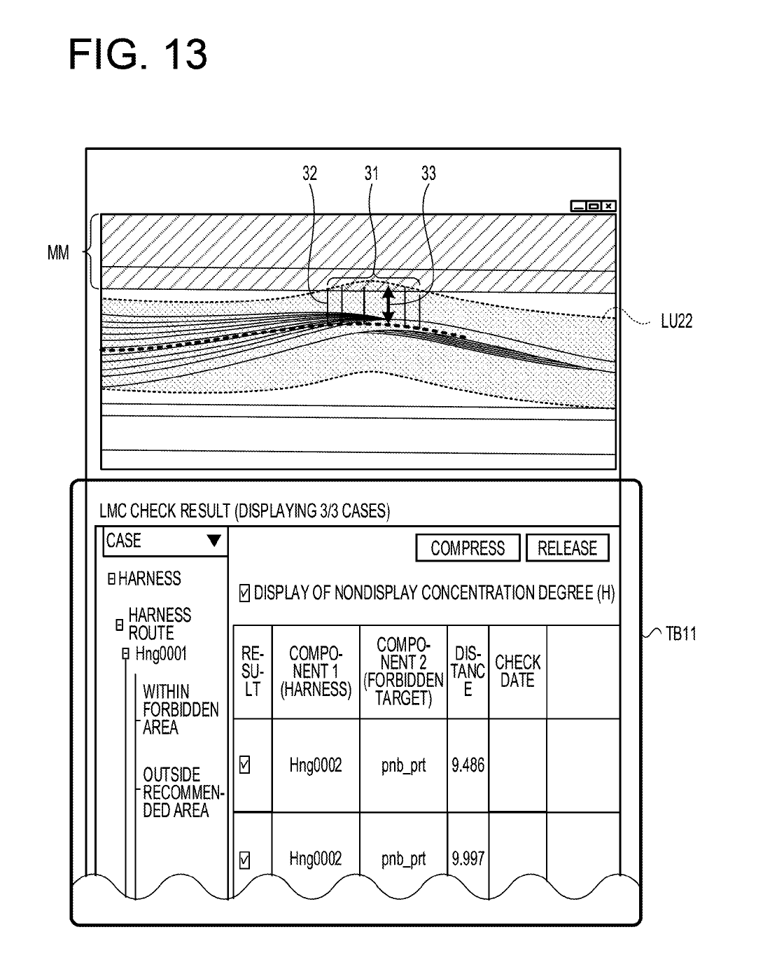

FIG. 13 is a diagram illustrating another example of the nonconformance result display according to the first embodiment. FIG. 13 illustrates a portion where a distance between the nonconformance portion 31 and the harness is nonconforming, with a straight line 32. Further, FIG. 13 illustrates a shortest point where the distance between the nonconformance portion 31 and the harness is the shortest, with an arrow 33.

### [Flow of Process]

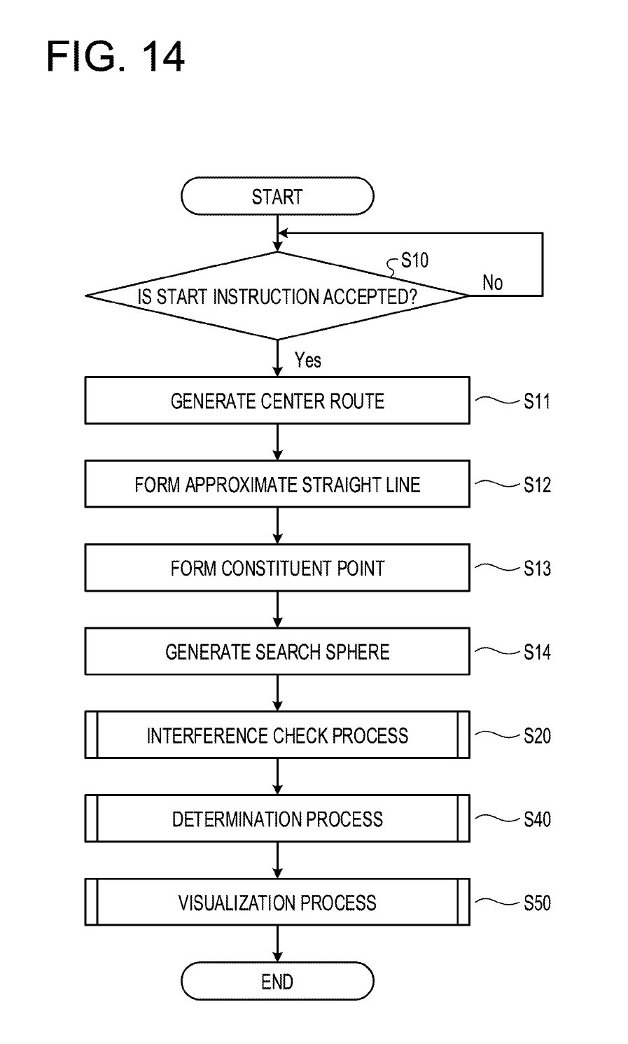

Next, the process in the embodiment will be described with reference to FIGS. 14 to 17. FIG. 14 is a flowchart illustrating an example of the verification process according to the first embodiment. As illustrated in FIG. 14, the route generation unit 141 of the verification apparatus 100 determines whether a start instruction is accepted through, for example, the external I/F 110 (S10). When it is determined that the start instruction is not accepted (“No” in S10), the route generation unit 141 waits until the start instruction is accepted.

When it is determined that the start instruction is accepted (“Yes” in S10), the route generation unit 141 generates the center route of the harness (S11). Next, the approximate straight line generation unit 142 generates the straight line that approximates the generated center route (S12). Next, the constituent point generation unit 143 forms the constituent point corresponding to the generated approximate straight line (S13). Next, the search sphere generation unit 144 generates the search sphere corresponding to the generated constituent point, and stores the generated search sphere in the search sphere DB 122 (S14).

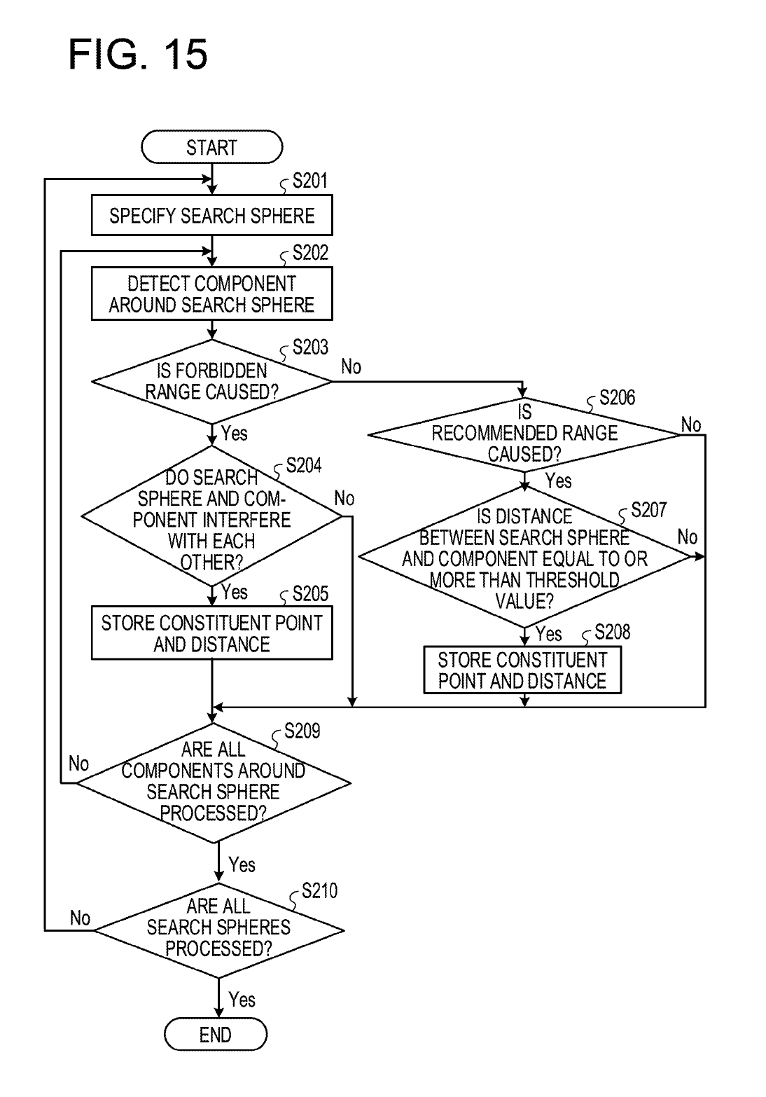

Next, the interference check unit 135 performs the interference check process (S20). FIG. 15 is a flowchart illustrating an example of an interference check process according to the first embodiment. First, the interference check unit 135 specifies an unprocessed search sphere by referring to the search sphere DB 122 (S201). Next, the interference check unit 135 detects components located around the specified search sphere (S202).

Next, the interference check unit 135 determines whether the component around the search sphere causes the forbidden range (S203). When it is determined that the component causes the forbidden range (“Yes” in S203), the interference check unit 135 determines whether the search sphere and the corresponding component interfere with each other (S204).

When it is determined that the search sphere interferes with the component (“Yes” in S204), the interference check unit 135 stores the information on the constituent point of the search sphere and the distance between the search sphere and the component in the nonconformance DB 123 (S205), and proceeds to S209. Meanwhile, when it is determined that the search sphere and the component do not interfere with each other (“No” in S204), the interference check unit 135 proceeds to S209 without storing the distance.

Referring back to S203, when it is determined that the component does not cause the forbidden range (“No” in S203), the interference check unit 135 determines whether the component around the search sphere causes the recommended range (S206). When it is determined that the component around the search sphere does not cause the recommended range (“No” in S206), the interference check unit 135 proceeds to S209 without performing the process.

Meanwhile, when it is determined that the component causes the recommended range (“Yes” in S206), the interference check unit 135 determines whether the distance between the search sphere and the component is equal to or more than a threshold value, that is, whether the search sphere deviates from the recommended range (S207).

When it is determined that the search sphere deviates from the recommended range (“Yes” in S207), the interference check unit 135 stores the information on the constituent point of the search sphere and the distance between the search sphere and the component in the nonconformance DB 123 (S208) and proceeds to S209. Meanwhile, when it is determined that the search sphere does not deviate from the recommended range (“No” in S207), the interference check unit 135 proceeds to S209 without storing the distance.

The interference check unit 135 determines whether processing all components around the search sphere is completed (S209). When it is determined that the processing of all of the components around the search sphere is not completed (“No” in S209), the interference check unit 135 returns to S202 and repeats the process. When it is determined that the processing of all of the components is completed (“Yes” in S209), the interference check unit 135 determines whether processing all search spheres is completed (S210). When it is determined that the processing of all of the search spheres is not completed (“No” in S210), the interference check unit 135 returns to S201 and repeats the process. When it is determined that the processing of all of the search spheres is completed (“Yes” in S210), the interference check unit 135 returns to the original process.

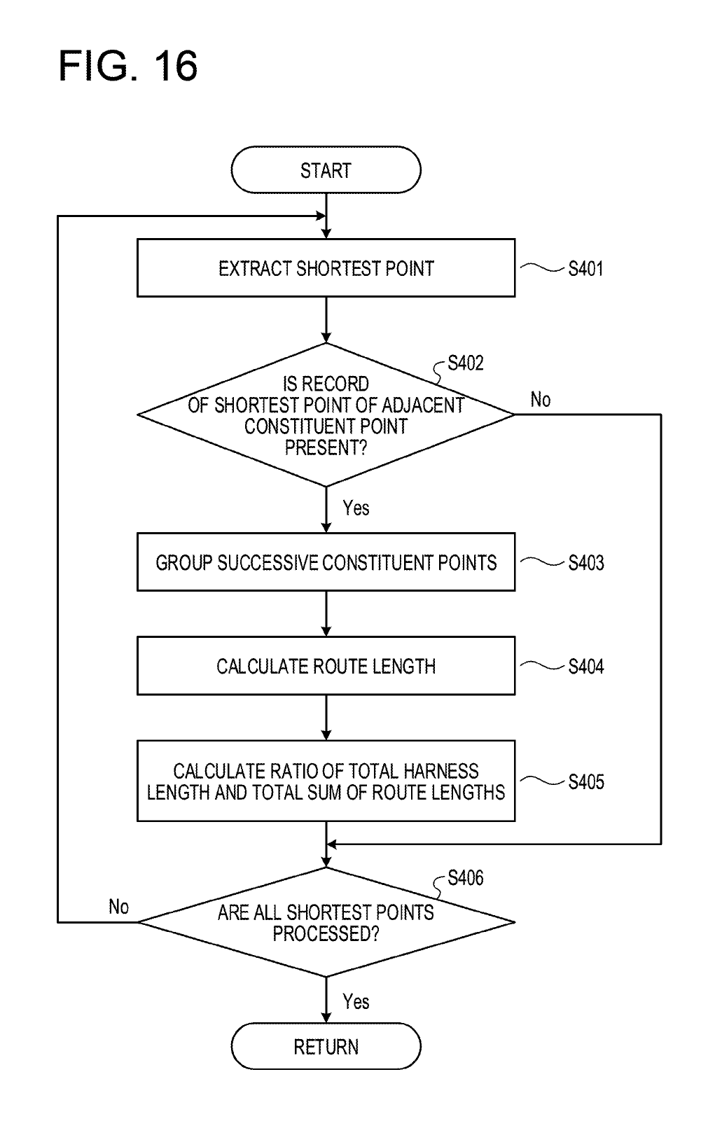

Next, the determination unit 136 performs the determination process (S40). FIG. 16 is a flowchart illustrating an example of a determination process according to the first embodiment. First, the determination unit 136 extracts the shortest point from the constituent points determined to be nonconforming by referring to the nonconformance DB 123 (S401). Next, the determination unit 136 determines whether there is a record of the shortest point with respect to constituent points adjacent to the shortest point (S402). When it is determined that there is no record of the shortest point (“No” in S402), the determination unit 136 proceeds to S406.

Meanwhile, when it is determined that there is the record of the shortest point (“Yes” in S402), the determination unit 136 groups the extracted shortest point and the adjacent constituent point (S403). Next, the determination unit 136 calculates a route length of the grouped shortest point (S404). Then, the determination unit 136 calculates the total sum of the route lengths of the grouped shortest points, that is, a ratio of the total extension of the portions determined to be nonconforming to the total length of the harness (S405). Thereafter, the determination unit 136 proceeds to S406.

Then, the determination unit 136 determines whether the processing of all of the shortest points is completed (S406). When it is determined that the processing of all of the shortest points is not completed (“No” in S406), the determination unit 136 returns to S401 and repeats the process. When it is determined that the processing of all of the shortest points is completed (“Yes” in S406), the determination unit 136 returns to the original process.

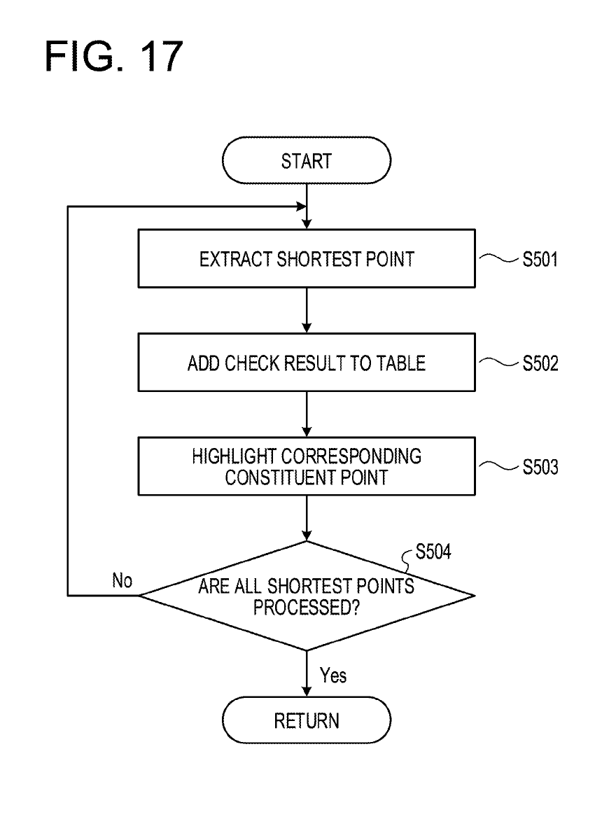

Then, the output unit 137 performs the visualization process (S50), and ends the process. FIG. 17 is a flowchart illustrating an example of a visualization process according to the first embodiment. As illustrated in FIG. 17, the output unit 137 extracts a shortest point having a smallest distance between the forbidden range and the search sphere among constituent points that are nonconforming by referring to the nonconformance DB 123 (S501). Next, the output unit 137 adds a check result of the shortest point to a table (S502).

Then, the output unit 137 highlights the constituent point corresponding to the shortest point (S503). The output unit 137 determines whether processing of all of the shortest points is completed (S504). When it is determined that the processing of all of the shortest points is not completed (“No” in S504), the output unit 137 returns to S501 and repeats the process. When it is determined that the processing of all of the shortest points is completed (“Yes” in S504), the output unit 137 returns to the original process.

### [Effects]

As described above, the verification apparatus 100 in the embodiment generates a search range that may include the constituent point at constituent points of a line approximating the center route of the string-like component or the band-like component arranged in the apparatus. The verification apparatus 100 checks whether there is interference between the search range and a range around the component of the apparatus. In addition, the verification apparatus 100 visualizes a check result. As a result, the verification apparatus 100 may reduce the calculation amount at the time of verifying the route.

The verification apparatus 100 sets the center router of the string-like component or the band-like component, and generates a straight line that approximates the center route. The verification apparatus 100 sets the constituent point at an intersection of the approximate straight line and the center route, and generates the search range including the constituent point. As a result, it is possible to further reduce the calculation amount.

The verification apparatus 100 may check whether the search range interferes with the forbidden range around the component of the apparatus, and highlight a portion where the search range interferes with the forbidden range as the nonconformance portion. The verification apparatus 100 may check whether the search range is included in the recommended range around the component of the apparatus, and highlight a portion where the search range deviates from the recommended range as the nonconformance portion. Further, the verification apparatus 100 may specify a section in which the search range successively interferes with the forbidden range, output information indicating a section length of the specified section, or display a line or an arrow at a location related to the nonconformance portion. As a result, the nonconformance portion may be effectively visualized.

### Second Embodiment

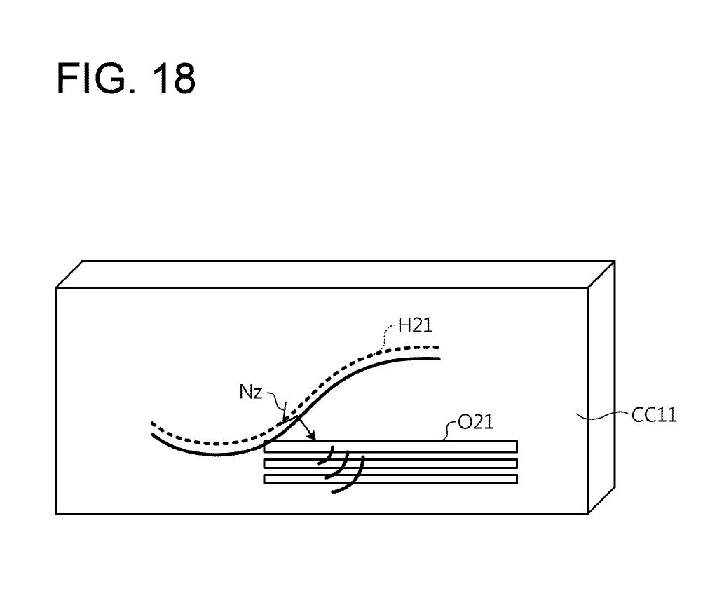

However, in addition to a portion where the harness is exposed to the outside of the apparatus, noise is radiated even in a portion where an opening is provided in the apparatus and the harness inside the apparatus may be visible from the outside through the opening. FIG. 18 is a diagram illustrating an example of a relationship between a harness and an opening according to a second embodiment. In FIG. 18, a harness H21 is not exposed to the outside of the apparatus, but may be viewed from the outside through an opening O21. In this case, noise Nz propagated to the harness H21 is radiated to the outside through the opening O21.

Even when the harness itself may not be viewed from the opening, when the portion corresponding to the search sphere of the harness may be viewed, the noise may be emitted from the opening in the same manner. Therefore, in the embodiment, a configuration to further determine whether the component such as the harness or the search sphere may be viewed from the opening will be described. Further, in the following description, a portion where, for example, the harness or the search sphere may be viewed through the opening may be referred to as an “exposed portion.”

### [Functional Block]

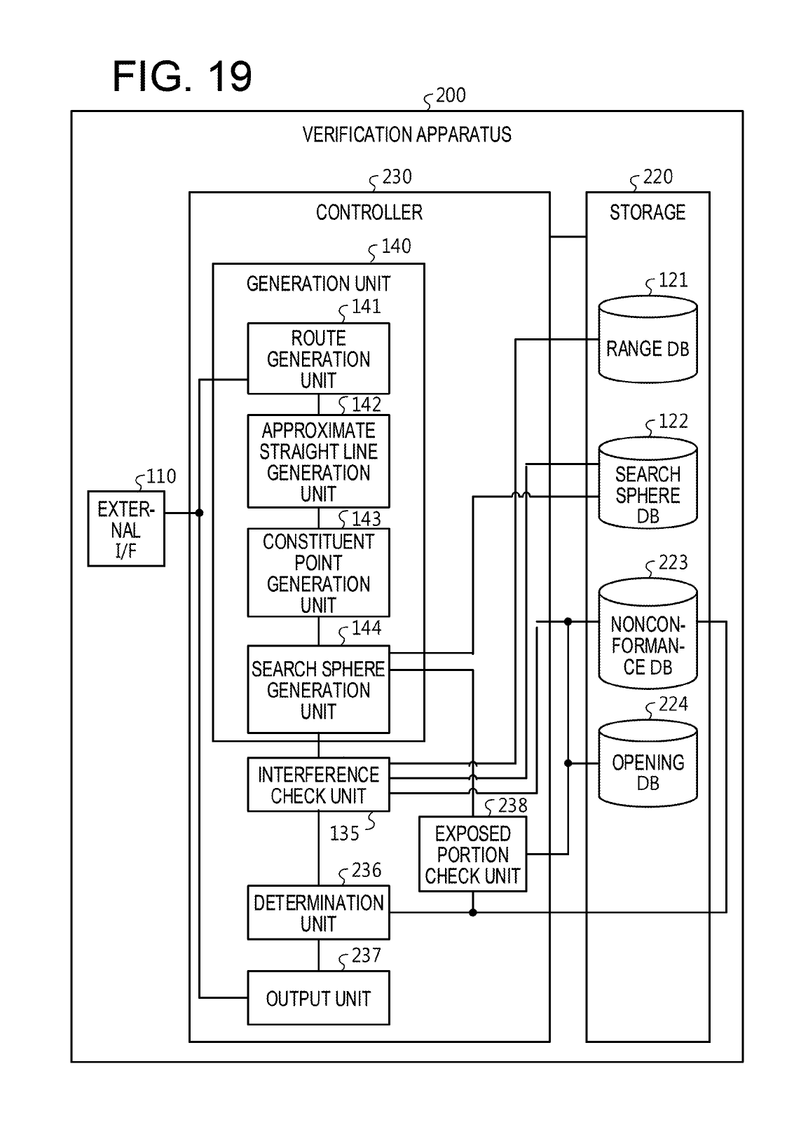

A verification apparatus 200 according to the embodiment will be described with reference to FIG. 19. FIG. 19 is a block diagram illustrating an example of a configuration of a verification apparatus according to the second embodiment. In addition, in the following embodiments, the same parts as those in the drawings described above will be denoted by the same reference numerals, and overlapping descriptions thereof will be omitted.

As illustrated in FIG. 19, the verification apparatus 200 according to the embodiment includes an external I/F 110, a storage 220, and a controller 230. The storage 220 stores, for example, various data such as a program executed by the controller 230. Further, the storage 220 includes a range DB 121, a search sphere DB 122, a nonconformance DB 223, and an opening DB 224.

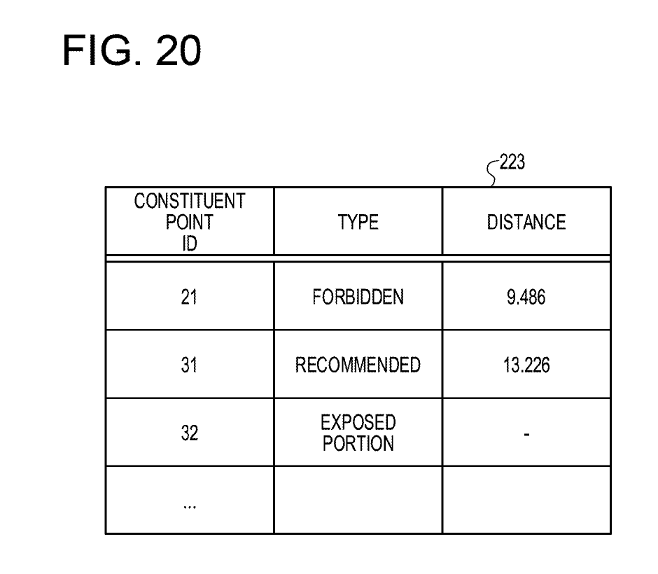

In addition to information indicating interference with the forbidden range of the search sphere and information indicating deviation from the recommended range of the search sphere as information on the search range determined to be nonconforming, the nonconformance DB 223 further stores information on exposure of the search sphere from the opening. FIG. 20 is a diagram illustrating an example of a nonconformance DB according to the second embodiment. As illustrated in FIG. 20, for example, the nonconformance DB 223 stores “type” and “distance” in association with the “constituent point ID,” as in the nonconformance DB 123. In FIG. 20, the “type” is information indicating whether the type of nonconformance is the exposure from the opening, in addition to whether the type of nonconformance is the interference with the forbidden range or the deviation from the recommended range.

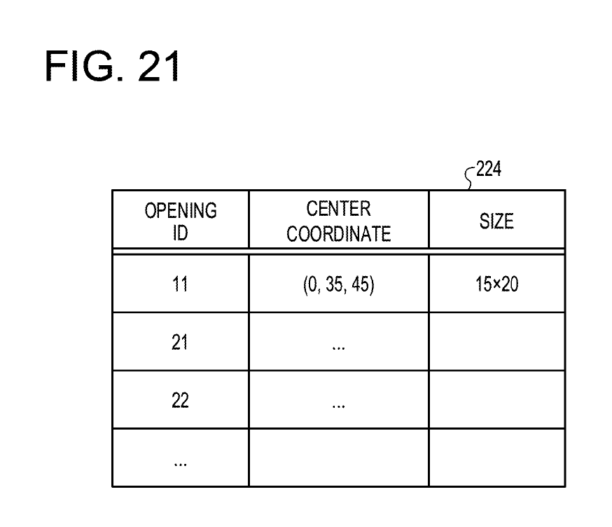

The opening DB 224 stores, for example, information regarding the opening included in the apparatus. FIG. 21 is a diagram illustrating an example of an opening DB according to the second embodiment. As illustrated in FIG. 21, the opening DB 224 stores “center coordinate” and “size” in association with “opening ID.” Further, the information stored in the opening DB 224 is input in advance by a manager (not illustrated) of the verification apparatus 200. The opening DB 224 stores, for example, each opening as one record.

In FIG. 21, the “opening ID” is an identifier for uniquely identifying the opening included in the apparatus. The “center coordinate” and the “size” are information indicating a position of the opening corresponding to the opening ID in the apparatus and a size of the corresponding opening. Further, the opening DB 224 may further store information on, for example, a shape of the opening.

Referring back to FIG. 19, the controller 230 is a processing unit that controls the entire verification apparatus 200 and is, for example, a processor. The controller 230 includes a generation unit 140, an interference check unit 135, a determination unit 236, an output unit 237, and an exposure portion check unit 238. Further, the determination unit 236 and the exposed portion check unit 238 are an example of an electronic circuit included in the processor and an example of a process executed by the processor.

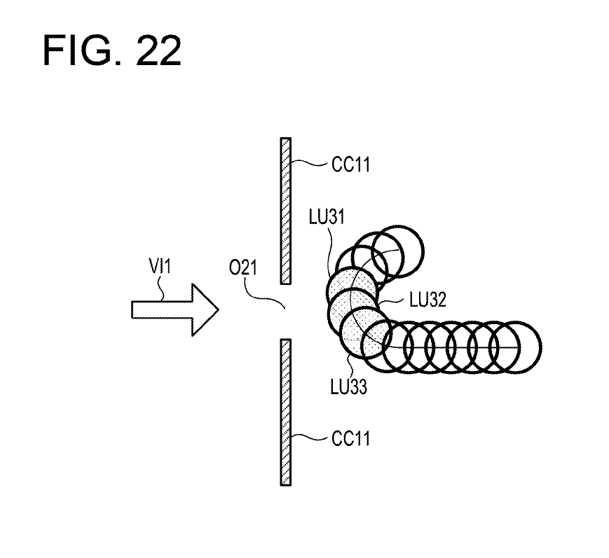

The exposed portion check section 238 determines whether the harness in the apparatus may be viewed from the opening included in the apparatus. FIG. 22 is a diagram illustrating an example of an exposed portion check process according to the second embodiment. As illustrated in FIG. 22, respective search spheres LU31 to LU33 generated in the apparatus may be viewed from a viewing direction VI1 through the opening O21 provided in the case CC11 of the apparatus. In this case, the exposed portion check unit 238 determines that the respective search spheres LU31 to the LU33 may be viewed from the opening O21. The exposed portion check unit 238 repeatedly checks the apparatus from upper and lower, left and right, and front and rear directions, and stores information on the respective search spheres LU31 to LU33 which are determined to be visible from the opening O21, in the nonconformance DB 223.

The determination unit 236 further determines whether there is a constituent point having successive exposed portions in addition to the constituent points having the successive shortest points, by referring to the nonconformance DB 223.

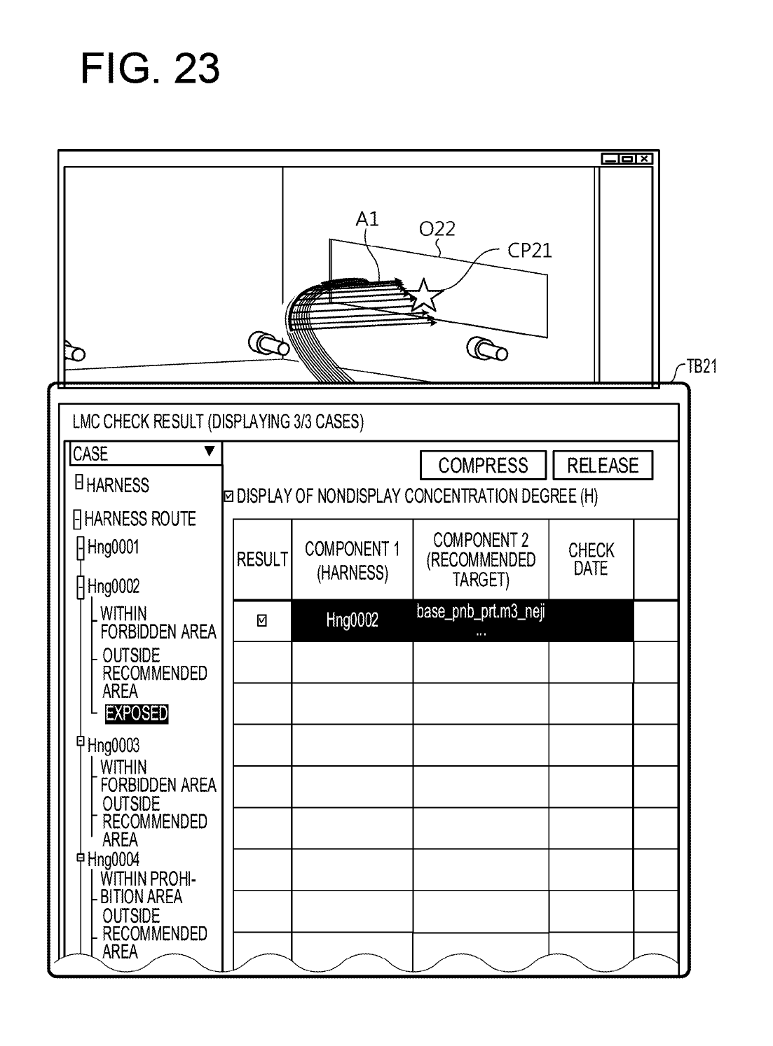

The output unit 237 outputs a result of the verification process in the second embodiment, which includes an exposed portion check process. FIG. 23 is a diagram illustrating an example of a nonconformance result display according to the second embodiment. FIG. 23 illustrates a nonconformance result including an indication indicating that the constituent point CP21 is visible from the outside at the opening portion O22. In FIG. 23, a table TB21 represents information on a portion of the harness A1 determined to be visible from the outside.

### [Flow of Process]

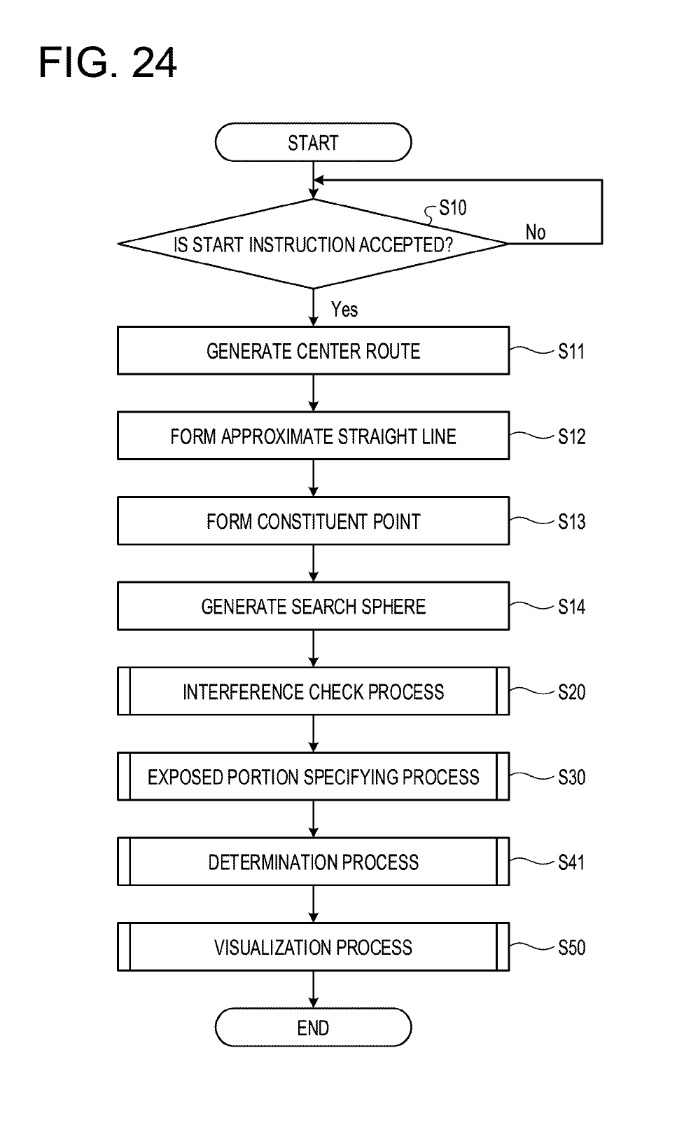

Next, the process in the embodiment will be described with reference to FIGS. 24 to 26. FIG. 24 is a flowchart illustrating an example of a verification process according to the second embodiment. Further, in the following description, detailed descriptions of the operations with the same reference numerals as those in FIGS. 14 to 16 will be omitted.

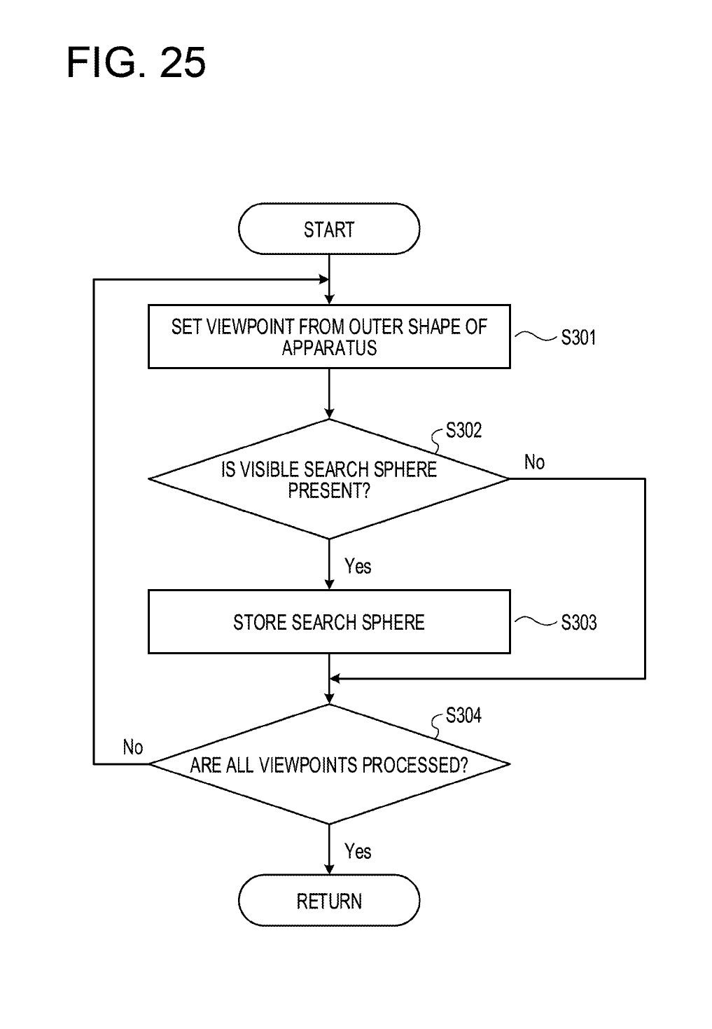

As illustrated in FIG. 24, the exposed portion check unit 238 of the verification apparatus 200 performs an exposed portion specifying process, following the interference check process of S20 (S30). FIG. 25 is a flowchart illustrating an example of an exposed portion specifying process according to the second embodiment. As illustrated in FIG. 25, the exposed portion check unit 238 first sets a viewpoint from any one of the upper and lower, left and right, and front and rear directions of the apparatus (S301).

Next, the exposed portion check unit 238 determines whether there is a search sphere visible through the opening from the viewpoint direction (S302). When it is determined that there is the visible search sphere (“Yes” in S302), the exposed portion check unit 238 stores information on the visible search sphere in the nonconformance DB 223 in association with the viewing direction (S303). Meanwhile, when it is determined that there is no visible search sphere (“No” in S302), the exposed portion check unit 238 proceeds to S304 without storing the information on the search sphere.

Next, the exposed portion check unit 238 determines whether processing from all viewpoint directions is completed (S304). When it is determined that the processing from all of the viewpoint directions is not completed (“No” in S304), the exposed portion check unit 238 returns to S301 and repeats the process. When it is determined that the processing of all of the viewpoint directions is completed (“Yes” in S304), the exposed portion check unit 238 returns to the original process.

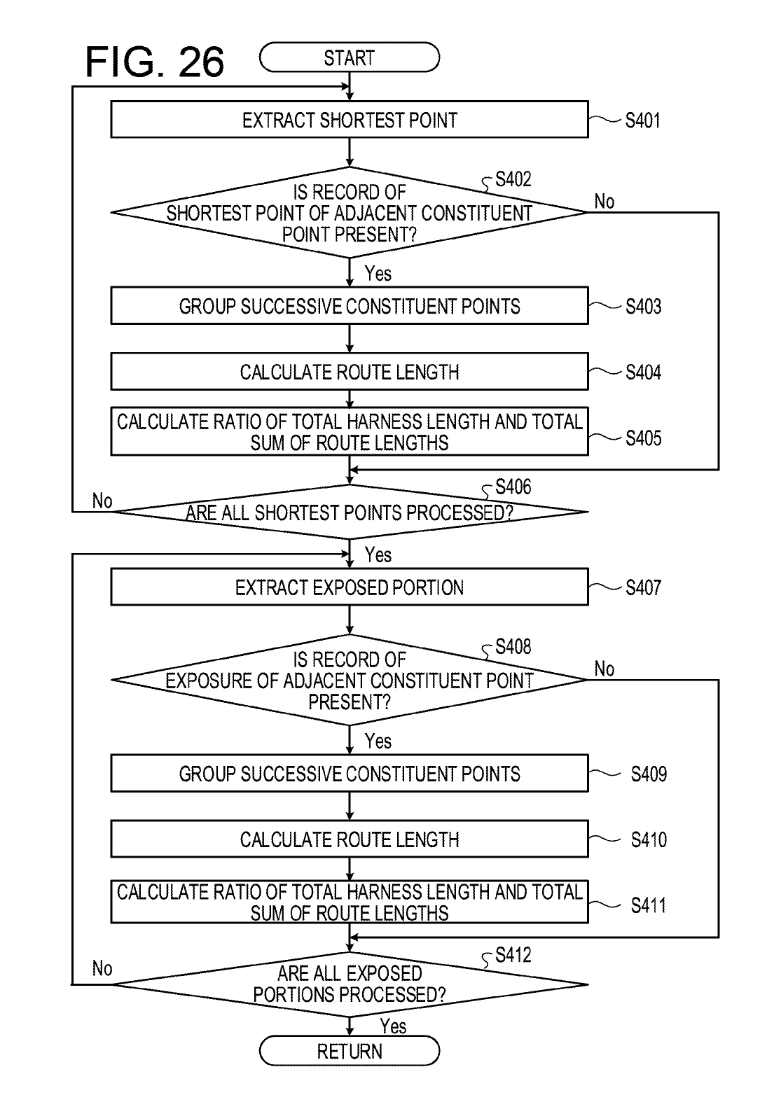

Next, the determination unit 236 performs the determination process (S41). FIG. 26 is a flowchart illustrating an example of a determination process according to the second embodiment. First, the determination unit 236 executes each operation from S401 to S406 illustrated in FIG. 16 by referring to the nonconformance DB 223. When it is determined that the processing of all of the shortest points is completed (“Yes” in S406), the determination unit 236 extracts the exposed portion by referring to the nonconformance DB 223 (S407).

Next, the determination unit 236 determines whether there is a record of the exposed portion with respect to the constituent point adjacent to the extracted exposed portion (S408). When it is determined that there is no record of the exposed portion (“No” in S408), the determination unit 236 proceeds to S412.

Meanwhile, when it is determined that there is the record of the exposed portion (“Yes” in S408), the determination unit 236 groups the extracted exposed portion and the adjacent constituent point (S409). Next, the determination unit 236 calculates a route length of the grouped exposed portion (S410). Then, the determination unit 236 calculates the total sum of the route lengths of the grouped exposed portions, that is, a ratio of the total extension of the portions determined to be nonconforming to the total length of the harness (S411). Thereafter, the determination unit 236 proceeds to S412.

Then, the determination unit 236 determines whether the processing of all of the exposed portions is completed (S412). When it is determined that the processing of all of the exposed portions is not completed (“No” in S412), the determination unit 236 returns to S407 and repeats the process. When it is determined that the processing of all of the exposed portions is completed (“Yes” in S412), the determination unit 236 returns to the original process.

### [Effects]

As described above, the verification apparatus 200 in the embodiment specifies a portion where the search range may be viewed from the outside of the apparatus, and highlights the search range included in the specified visible portion as the nonconformance portion. As a result, even when the harness itself may not be viewed from the opening, a possibility of emitting the noise may be detected.

### Third Embodiment

However, when the verification apparatus detects the nonconformance portion in the interference check process or the exposed portion check process, for example, the nonconformity portion may be eliminated by adjusting the position of the harness. Therefore, in this embodiment, a configuration to adjust the position of the harness of the nonconformance portion will be described.

### [Functional Block]

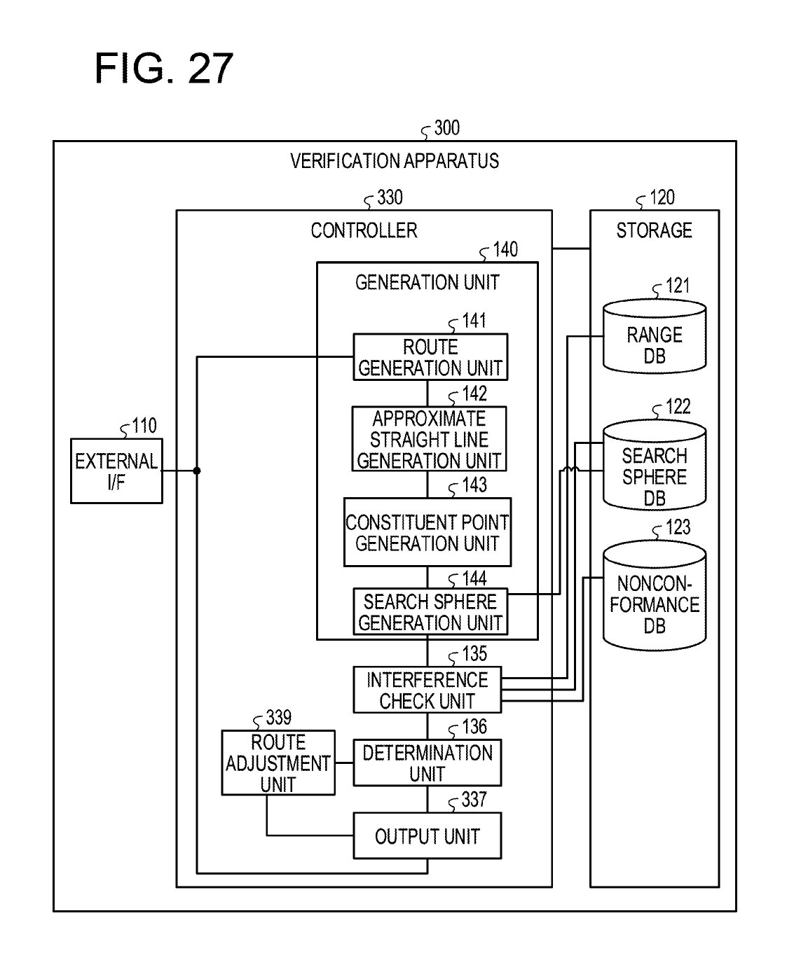

Next, an example of a verification apparatus 300 according to the embodiment will be described with reference to FIG. 27. FIG. 27 is a block diagram illustrating an example of a configuration of a verification apparatus according to a third embodiment. As illustrated in FIG. 27, the verification apparatus 300 includes an external I/F 110, a storage 120, and a controller 330.

The controller 330 is a processing unit that controls the entire verification apparatus 300 and is, for example, a processor. The controller 330 includes a generation unit 140, an interference check unit 135, a determination unit 136, an output unit 337, and a route adjustment unit 339. Further, the route adjustment unit 339 is an example of an electronic circuit included in the processor and an example of a process executed by the processor.

The route adjustment unit 339 adjusts the route of the harness including the nonconformance portion. The route adjustment unit 339 eliminates the nonconformance portion by, for example, adjusting the position of the harness whose search sphere is determined to interfere with the forbidden range. For example, the route adjustment unit 339 may automatically adjust the route by a known technique or may accept an instruction for the adjustment of the route through the external I/F 110 and may adjust the route according to the instruction.

The route adjustment unit 339 specifies the position of the shortest point in the forbidden range and the distance from the constituent point corresponding to the search sphere to the shortest point by, for example, the range DB 121, the search sphere DB 122, and the nonconformance DB 123. In addition, for example, the route adjustment unit 339 specifies a direction from the constituent point up to the shortest point and moves the constituent point in an opposite direction to the shortest point so that the distance is larger than the size of the forbidden range to adjust the route.

The route adjustment unit 339 uses, for example, “radius (forbidden)” among the information on the size of the search range stored in the search sphere DB 122, but the embodiment is not limited thereto. For example, the search sphere DB 122 may be configured to further store the radius used for checking the exposed portion.

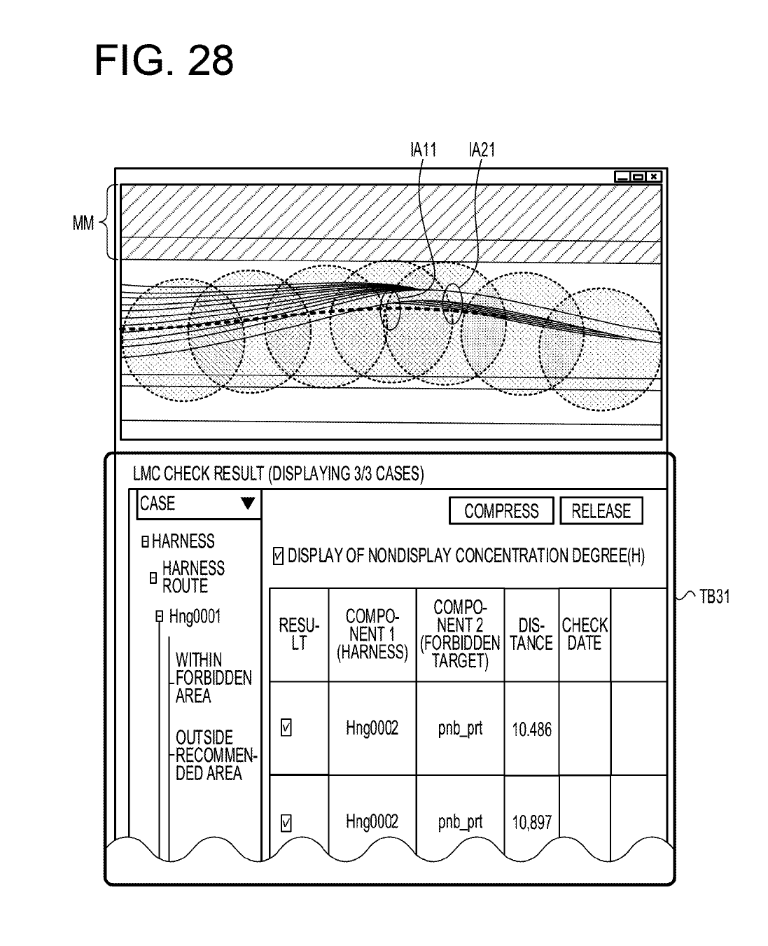

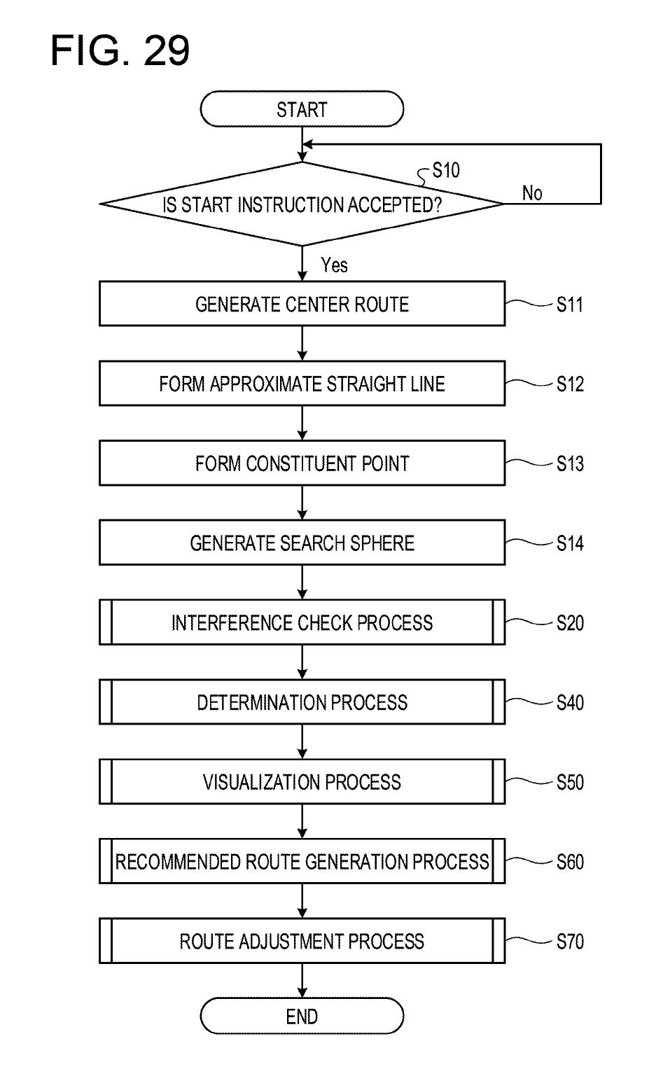

The output unit 337 outputs a result of the verification process in the third embodiment, which includes a recommended route generation process and a route adjustment process. FIG. 28 is a diagram illustrating an example of a correction display according to the third embodiment. In the diagram illustrated in FIG. 28, the positions of the interference portions IA1 and IA2 of the harness in the nonconformance result display in FIG. 11 are modified to IA11 and IA21. As a result, the nonconformance portions MM1 and MM2 in FIG. 11 are eliminated in FIG. 28. Further, the table TB11 representing the position of each harness in FIG. 11 is also updated as illustrated in a table TB31 in FIG. 28 according to the movement of the harness.

For example, the route adjustment unit 339 eliminates the nonconformance portion by adjusting the position of the harness whose search sphere determined to deviate from the recommended range. For example, the route adjustment unit 339 specifies the distance and direction from the constituent point of the search sphere which deviates from the recommended range to the recommended range, by referring to the nonconformance DB 123. For example, the route adjustment unit 339 generates the recommended route of the harness by bringing the constituent point close to the direction of the recommended range. Then, for example, the route adjustment unit 339 highlights the route of the harness passing through the recommended.

### [Flow of Process]

Next, the process in the embodiment will be described with reference to FIGS. 29 to 31. Further, in the following description, detailed descriptions of the operations with the same reference numerals as those in FIG. 14 of the first embodiment will be omitted.

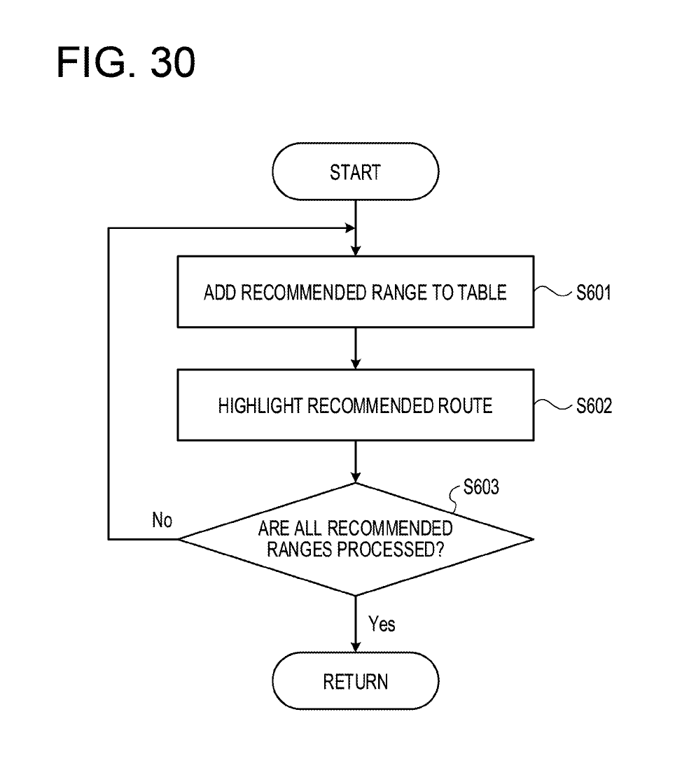

FIG. 29 is a flowchart illustrating an example of a verification process according to the third embodiment. As illustrated in FIG. 29, the route adjustment unit 339 of the verification apparatus 300 performs the recommended route generation process, following the visualization process of S50 (S60). FIG. 30 is a flowchart illustrating an example of a recommended route generating process according to the third embodiment. As illustrated in FIG. 30, the route adjustment unit 339 first extracts the recommended range stored in the range DB 121 and adds the extracted recommended range to the table represented in TB31 in FIG. 28 (S601).

Next, the route adjustment unit 339 highlights the recommended route of the harness included in the recommended range added to the table (S602). Then, the route adjustment unit 339 determines whether processing on all recommended ranges is completed (S603). When it is determined that the processing on all of the recommended ranges is not completed (“No” in S603), the route adjustment unit 339 returns to S601 and repeats the process. When it is determined that the processing on all of the recommended ranges is completed (“Yes” in S603), the route adjustment unit 339 returns to the original process.

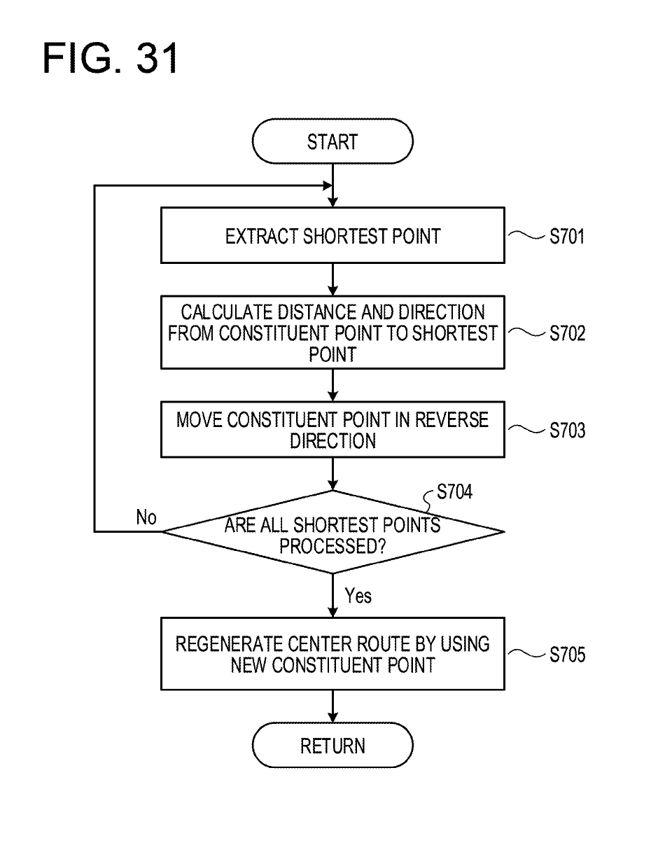

Next, the route adjustment unit 339 performs the route adjustment process (S70). FIG. 31 is a flowchart illustrating an example of a route adjustment process according to the third embodiment. First, the route adjustment unit 339 extracts the shortest point by referring to the nonconformance DB 123 (S701). Next, the route adjustment unit 339 calculates the distance and the direction from the constituent point corresponding to the shortest point to the shortest point (S702). Then, the route adjustment unit 339 moves the constituent point in a reverse direction so that the distance from the constituent point to the shortest point does not interfere with the forbidden range (S703).

Then, the route adjustment unit 339 determines whether the processing on all of the shortest points is completed (S704). When it is determined that the processing on all of the shortest points is not completed (“No” in S704), the route adjustment unit 339 returns to S701 and repeats the process. When it is determined that the processing on all of the shortest points is completed (“Yes” in S704), the route adjustment unit 339 regenerates the center route of the harness using a new constituent point after the movement (S705), and returns to the original process.

### [Effects]

As described above, the verification apparatus 300 in the embodiment accepts a selection of the nonconformance portion and moves the nonconformance portion of which selection is accepted, thereby moving the search range included in the nonconformance portion out of the range of the nonconformance portion. At that time, the verification apparatus 300 may accept the selection of the direction of moving the nonconformance portion. As a result, the arrangement of the harness may be reconfigured so that the radiation of the noise is reduced.

### Fourth Embodiment

Although the embodiments of the present disclosure have been described, the present disclosure may be implemented in various different forms in addition to the above-described embodiments. For example, although the configuration in which the verification apparatus 300 adjusts the route of the harness has been described in the third embodiment, a configuration to display an advice for correction of the route of the harness may also be adopted. In this way, by outputting information on elimination of nonconformance of the accepted nonconformance portion, the correction of the nonconformance portion may be urged.

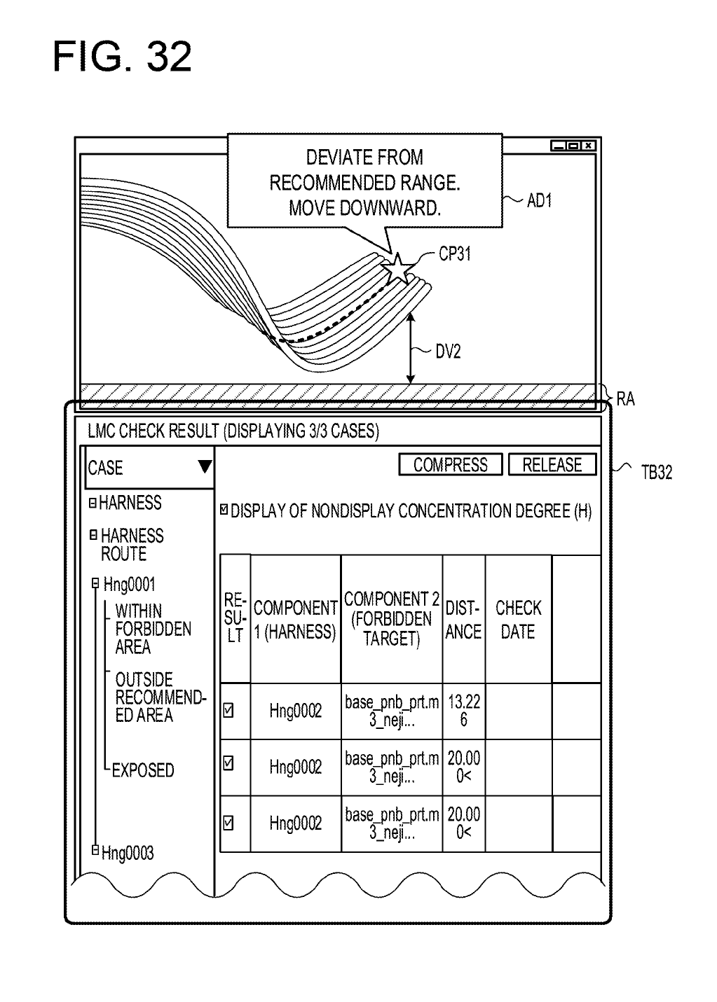

FIG. 32 is a diagram illustrating an example of a nonconformance result display according to a fourth embodiment. The nonconformance result display illustrated in FIG. 32 includes an advice AD1 including deviation from the recommended range and urging the downward movement for the nonconformance portion. For example, FIG. 32 further includes, a table TB32 including information DV2 indicating a distance at which the constituent point CP31 deviates from the recommended range and information on the constituent point CP31.

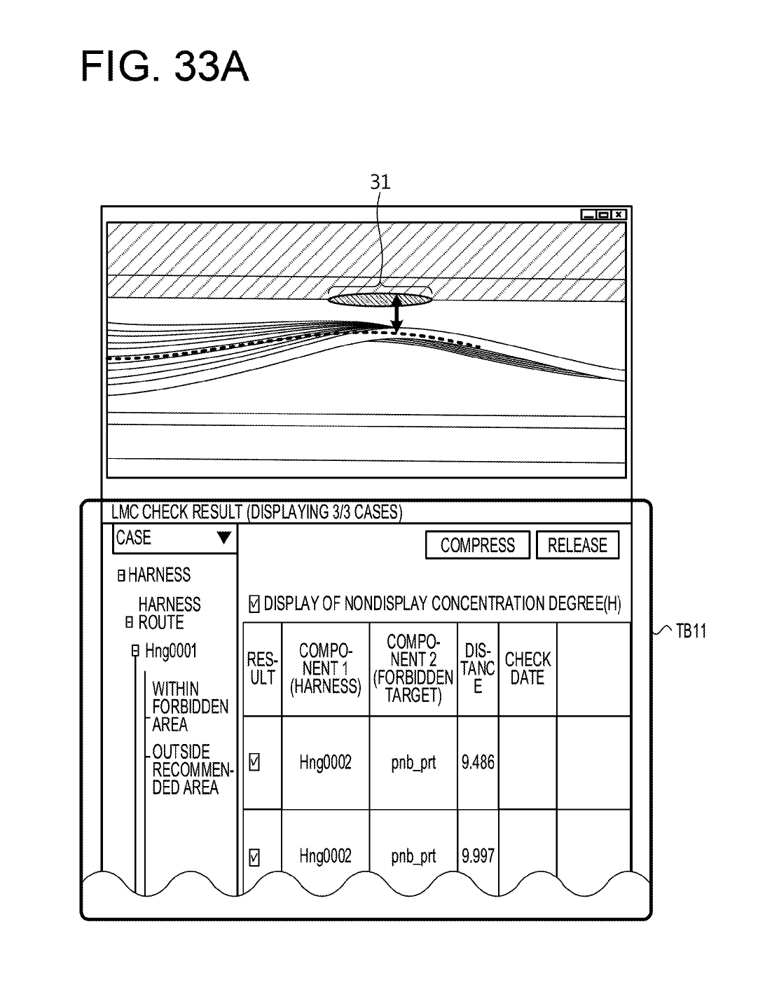

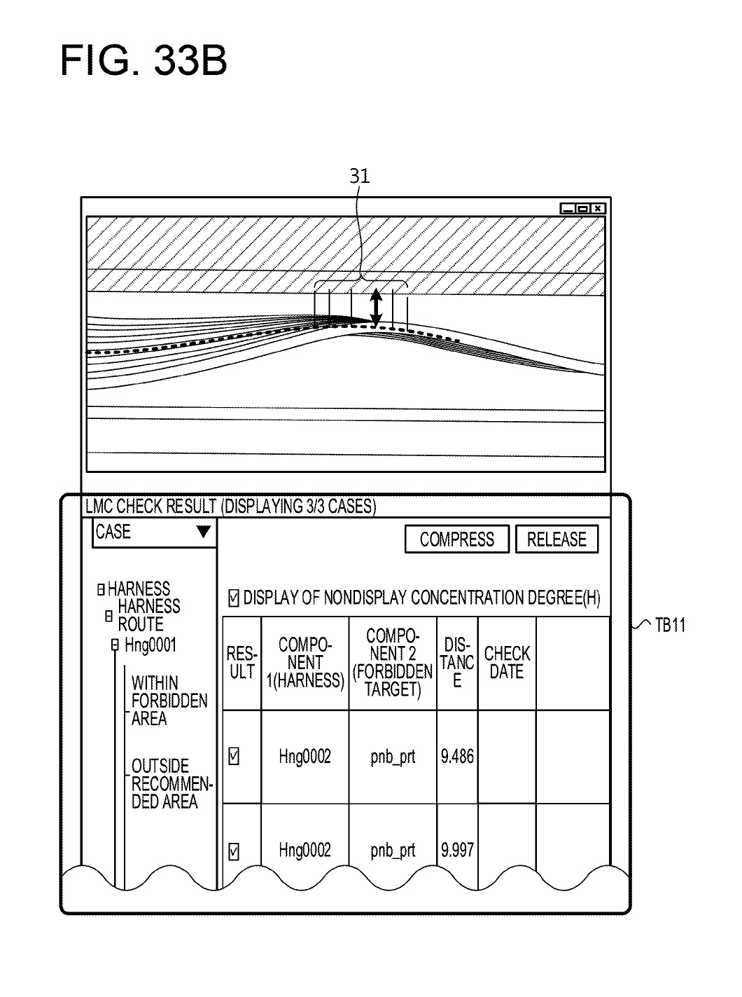

FIGS. 33A and 33B are diagrams illustrating another example of the nonconformance result display according to the fourth embodiment. The nonconformance result display illustrated in FIG. 33A is obtained by excluding the search range LU22 from the nonconformance result display in the first embodiment illustrated in FIG. 12. Similarly, the nonconformance result display illustrated in FIG. 33B is obtained by excluding the search range LU22 from the nonconformance result display in the first embodiment illustrated in FIG. 13.

The verification apparatus 100 may not have the range DB 121 but may be configured to employ external computer aided design (CAD) data. Similarly, the verification apparatus 200 may not have the opening DB 224 but may be configured to employ the external CAD data.

The search range is not limited to a spherical shape, but may be, for example, an ellipsoid or rectangular parallelepiped with the harness as the center. Further, in each embodiment, all of the search spheres corresponding to the harness have the same size, but may individually have different sizes. Further, in the interference check with the recommended range and the interference check with the forbidden range, search spheres of the same size may be used without separately defining the radius.

In the second embodiment, the configuration to detect the harness or search sphere which is visible through the opening has been described, but a configuration that may further specify, for example, the distance from the opening to the search sphere may also be adopted. Further, a configuration to adjust an angle of the position at which the opening is viewed and detect, for example, the visible harness or search sphere may be adopted. In addition, a configuration may be adopted to further specify information on a portion in which the inside of the apparatus may not be viewed but noise is radiated, in addition to the opening in which the inside of the apparatus may be viewed.

### [System]

Among the respective processes described in the embodiment, some of the process described as being performed automatically may be performed manually. Alternatively, all or some of the processes described as being performed manually may be automatically performed by a known method. In addition, the processing procedures, control procedures, specific names, and information including various data and parameters represented in the descriptions above or the drawings may be changed arbitrarily unless otherwise specified.

Each component of each apparatus illustrated is functionally conceptual and is not necessarily required to be configured physically as illustrated. That is, specific forms of distribution or integration of the respective apparatuses are not limited to those illustrated. All or some of the apparatuses may be configured to be functionally or physically distributed or integrated in arbitrary units according to, for example, various loads or use situations. In addition, all or some of the respective processing functions performed by each device may be implemented by a CPU and a program analyzed and executed by the CPU or may be implemented as hardware by a wired logic. Further, the verification apparatus 100 is implemented by, for example, a stand-alone computer but is not limited thereto. The verification apparatus 100 may be a server computer capable of communicating with a computer wirelessly or by wire, or may be mounted on a cloud.

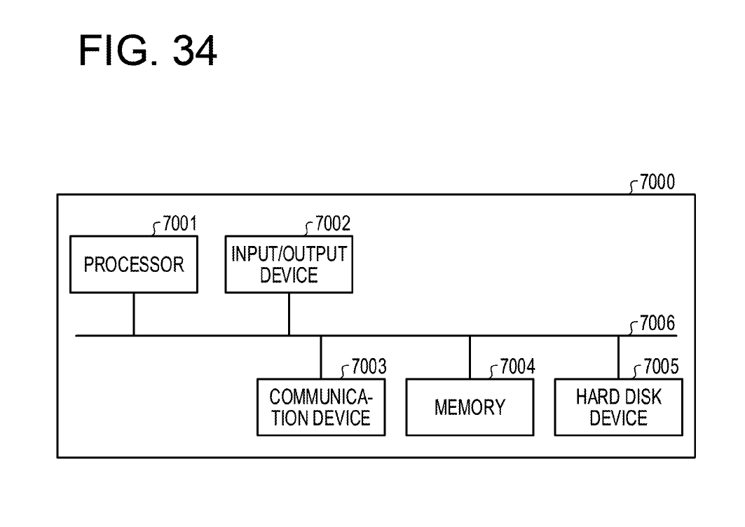

Various processing described in each embodiment described above may be implemented by executing a program prepared in advance by means of the computer. Therefore, in the following, an example of a computer that executes a program having the same function as the above embodiment will be described. FIG. 34 is a diagram illustrating an example of a hardware configuration. As illustrated in FIG. 34, for example, the verification apparatus 100 may be implemented with the same hardware configuration as the computer 7000 illustrated in FIG. 34. Further, in the following description, the verification apparatus 100 in the first embodiment will be described as an example, but each of the corresponding devices in the other embodiments may be implemented by the same computer.

As illustrated in FIG. 34, the computer 7000 includes a processor 7001 that executes various arithmetic processes, an input/output device 7002, a communication device 7003, a memory 7004 that temporarily stores various pieces of information, and a hard disk device 7005. In addition, each of the devices 7001 to 7005 is connected to a bus 7006.

Examples of the memory 7004 may include, for example, a random access memory (RAM) such as a synchronous dynamic random access memory (SDRAM), a read only memory (ROM), and a flash memory. One example of the processor 7001 may include, for example, a central processing unit (CPU), a digital signal processor (DSP), and a programmable logic device (PLD). In addition, the processor 7001 may be implemented by an integrated circuit such as an application specific integrated circuit (ASIC) or a field programmable gate array (FPGA).

The hard disk drive 7005 stores a verification program having the same functions as the generation unit 140, the interference check unit 135, the determination unit 136, and the output unit 137 of FIG. 5 described in the first embodiment. Further, the hard disk drive 7005 stores various data for implementing the verification program, such as the range DB 121, the search sphere DB 122, and the nonconformance DB 123.

The processor 7001 reads each program stored in the hard disk device 7005, and develops and executes the read program in the memory 7004, thereby performing various processing. Further, the program may cause the computer 7000 to function as the generation unit 140, the interference check unit 135, the determination unit 136, and the output unit 137 of FIG. 5 described in the first embodiment. Further, each program described above needs not be stored in the hard disk device 7005. For example, the computer 7000 may read and execute a program stored in a storage medium readable by the computer 7000.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a program that causes a computer to execute a procedure, the procedure comprising:
generating a search range configured to include a constituent point for constituting a line which approximates a center route of a string-like component or a band-like component disposed in a device at which an influence of electromagnetic noise is verified;
checking whether there is an interference between the search range and a range around a component mounted on the device; and
visualizing a result of the checking.

2. The non-transitory computer-readable recording medium according to claim 1,
wherein the procedure generates a search sphere centered on the constituent point as the search range.

3. The non-transitory computer-readable recording medium according to claim 1, the procedure further comprising:
setting the center route of the string-like component or the band-like component;
generating a straight line to approximate the center route; and
setting the constituent point at an intersection between the approximated straight line and the center route to generate the search range configured to include the constituent point.

4. The non-transitory computer-readable recording medium according to claim 1, wherein the procedure:
checks whether the search range interferes with a forbidden range around the component mounted on the device, and
visualizes a portion where the search range interferes with the forbidden range as a nonconformance portion.

5. The non-transitory computer-readable recording medium according to claim 4, wherein the procedure:
specifies a section in which the search range successively interferes with the forbidden range, and
generates information for indicating a section length of the specified section to visualize the nonconformance portion.

6. The non-transitory computer-readable recording medium according to claim 1, wherein the procedure:
checks whether the search range is included in a recommended range around the component mounted on the device, and
visualizes a portion where the search range deviates from the recommended range as a nonconformance portion.

7. The non-transitory computer-readable recording medium according to claim 1, the procedure further comprising:
specifying a portion capable of viewing the search range from an outside of the device, and
visualizes the search range included in the specified viewable portion as a nonconformance portion.

8. The non-transitory computer-readable recording medium according to claim 4, the procedure further comprising:
selecting the nonconformance portion; and
moving the search range included in the nonconformance portion out of a range of the nonconformance portion by moving the selected nonconformance portion.

9. The non-transitory computer-readable recording medium according to claim 8,
wherein the procedure selects a direction of moving the nonconformance portion.

10. The non-transitory computer-readable recording medium according to claim 8, the procedure further comprising:
wherein the procedure visualizes information regarding elimination of nonconformance of the nonconformance portion.

11. The non-transitory computer-readable recording medium according to claim 4,
wherein the procedure displays a line or an arrow at a location related to the nonconformance portion.

12. A verification apparatus comprising:
a memory; and
a processor coupled to the memory and the processor configured to:
generate a search range configured to include a constituent point for constituting a line which approximates a center route of a string-like component or a band-like component disposed in a device at which an influence of electromagnetic noise is verified;
check whether there is an interference between the search range and a range around a component mounted on the device; and
visualize a result of the checking.

13. A verification method comprising:
generating a search range configured to include a constituent point for constituting a line which approximates a center route of a string-like component or a band-like component disposed in a device at which an influence of electromagnetic noise is verified;
checking whether there is an interference between the search range and a range around a component mounted on the device; and
visualizing a result of the checking, by a processor.
